(19) United States
(12) Patent Application Publication
(10) Pub. No.: US 2021/0196436 A1
(43) Pub. Date: Jul. 1, 2021

(54) ARTICLES INCLUDING A COUPLING TO ENGAGE A TOOL, KITS, ADDITIVE MANUFACTURING METHODS OF MAKING SAME, AND METHODS OF COMPUTING MODELS OF THE ARTICLES

(71) Applicant: 3M INNOVATIVE PROPERTIES COMPANY, St. Paul, MN (US)

(72) Inventors: Richard E. Raby, Lino Lakes, MN (US); Paul J. Homnick, Lake Elmo, MN (US)

(21) Appl. No.: 17/128,418

(22) Filed: Dec. 21, 2020

Related U.S. Application Data
(60) Provisional application No. 62/954,283, filed on Dec. 27, 2019.

(51) Int. Cl. A61C 13/00; B33Y 80/00; B33Y 10/00; B33Y 30/00; B33Y 40/20; B33Y 70/10

(52) U.S. Cl. CPC A61C 13/0004; A61C 13/0019; B33Y 80/00; B33Y 70/10; B33Y 30/00; B33Y 40/20; B33Y 10/00

(57) ABSTRACT

The present disclosure provides an additive manufactured article including a first portion and a second portion integral to the first portion. The second portion includes a coupling configured to engage a tool, as well as a frangible section at a connection point to the first portion. Further, a method of making the article is provided, including obtaining a photopolymerizable material and selectively curing the photopolymerizable material to form the article. Another method is provided, including obtaining a digital three-dimensional model of a patient's dental anatomy comprising a tooth in need of restoration and computing a digital three-dimensional model of a dental restoration to fit within the patient's dental anatomy, including determining a shape of the dental restoration. Optionally, the patient's dental anatomy may be prepared for a dental restoration prior to obtaining the digital three-dimensional model. A kit is also provided, including the article and a tool configured to attach to the coupling of the article. Having a coupling integral to the rest of the article allows for easy attachment to a handling tool.

### CROSS REFERENCE TO RELATED APPLICATIONS

This application claims priority from U.S. Provisional Application Ser. No. 62/954,283, filed Dec. 27, 2020, the disclosure of which is incorporated by reference in its entirety herein.

### SUMMARY

The present disclosure generally relates to additive manufactured articles, their preparation, and use.

In a first aspect, the present disclosure provides an additive manufactured article comprising a first portion and a second portion integral to the first portion. The second portion comprises a coupling configured to engage a tool, and the second portion comprises a frangible section at a connection point to the first portion.

In a second aspect, the present disclosure provides a method of making the article according to the first aspect. The method comprises a) obtaining photopolymerizable material; and b) selectively curing the photopolymerizable material to form an additive manufactured article according to the first aspect.

In a third aspect, the present disclosure provides a kit comprising the article according to the first aspect and a tool configured to attach to the coupling of the article.

In a fourth aspect, the present disclosure provides a method comprising a) obtaining a digital three-dimensional model of a patient's dental anatomy comprising a tooth in need of restoration; and b) computing a digital three-dimensional model of a dental restoration to fit within the patient's dental anatomy, wherein the computing comprises determining a shape of the dental restoration. The dental restoration is an article according to the first aspect.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF DRAWINGS

FIG. 1 is a schematic perspective view of an exemplary article attached to a tool.

FIG. 2 is a schematic perspective view of a tool configured to engage the article of FIG. 1.

FIG. 3 is a schematic perspective view of another exemplary article attached to a tool.

FIG. 4 is a schematic perspective view of an additional exemplary article attached to a tool placing a dental restoration in a tooth.

FIG. 5 is a schematic top view of the article and tool of FIG. 4.

FIG. 6A is a schematic perspective view of an exemplary article attached to a tool and employing a registration feature to assist in placement of the article in a tooth.

FIG. 6B is a schematic perspective view of an exemplary article attached to a tool placing the article on a tooth.

FIG. 7 is a schematic perspective view of an exemplary article having more than one connection point and attached to a tool.

FIG. 8A is a schematic perspective view of an exemplary article having a coupling with a friction fit connection.

FIG. 8B is a schematic perspective view of the article of FIG. 8A with a light guide engaged with the coupling and shining light through the article.

FIG. 9 is a high-level flow chart of an exemplary method of making an additive manufactured article.

FIG. 10 is a high-level flow chart of another exemplary method.

FIG. 11 is a block diagram of a generalized system 11500 for additive manufacturing of an article.

FIG. 12 is a block diagram of a generalized manufacturing process for an article.

FIG. 13 is a high-level flow chart of an exemplary article manufacturing process.

FIG. 14 is a high-level flow chart of an exemplary article additive manufacturing process.

FIG. 15 is a schematic front view of an exemplary computing device 5000.

FIG. 16 is a generalized schematic of a stereolithography apparatus 200.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity but to include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

As used herein, “aliphatic group” means a saturated or unsaturated linear, branched, or cyclic hydrocarbon group. This term is used to encompass alkyl, alkenyl, and alkynyl groups, for example.

As used herein, “alkyl” means a linear or branched, cyclic or acyclic, saturated monovalent hydrocarbon having from one to thirty-two carbon atoms, e.g., methyl, ethyl, 1-propyl, 2-propyl, pentyl, and the like.

As used herein, “alkylene” means a linear saturated divalent hydrocarbon having from one to twelve carbon atoms or a branched saturated divalent hydrocarbon radical having from three to twelve carbon atoms, e.g., methylene, ethylene, propylene, 2-methylpropylene, pentylene, hexylene, and the like.

As used herein, each of “alkenyl” and “ene” refers to a monovalent linear or branched unsaturated aliphatic group with one or more carbon-carbon double bonds, e.g., vinyl.

As used herein, the term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

As used herein, “aralkylene” refers to a divalent group that is an alkylene group substituted with an aryl group or an alkylene group attached to an arylene group. The term “alkarylene” refers to a divalent group that is an arylene group substituted with an alkyl group or an arylene group attached to an alkylene group. Unless otherwise indicated, for both groups, the alkyl or alkylene portion typically has from 1 to 20 carbon atoms, 1 to 10 carbon atoms, 1 to 6 carbon atoms, or 1 to 4 carbon atoms. Unless otherwise indicated, for both groups, the aryl or arylene portion typically has from 6 to 20 carbon atoms, 6 to 18 carbon atoms, 6 to 16 carbon atoms, 6 to 12 carbon atoms, or 6 to 10 carbon atoms.

As used herein, the term “(meth)acrylate” is a shorthand reference to acrylate, methacrylate, or combinations thereof, “(meth)acrylic” is a shorthand reference to acrylic, methacrylic, or combinations thereof, and “(meth)acryl” is a shorthand reference to acryl and methacryl groups. “Acryl” refers to derivatives of acrylic acid, such as acrylates, methacrylates, acrylamides, and methacrylamides. By “(meth)acryl” is meant a monomer or oligomer having at least one acryl or methacryl groups, and linked by an aliphatic segment if containing two or more groups. As used herein, “(meth)acrylate-functional compounds” are compounds that include, among other things, a (meth)acrylate moiety.

As used herein, the term “hardenable” refers to a material that can be cured or solidified, e.g., by heating to remove solvent, heating to cause polymerization, chemical crosslinking, radiation-induced polymerization or crosslinking, or the like.

As used herein, “curing” means the hardening or partial hardening of a composition by any mechanism, e.g., by heat, light, radiation, e-beam, microwave, chemical reaction, or combinations thereof. As used herein, “cured” refers to a material or composition that has been hardened or partially hardened (e.g., polymerized or crosslinked) by curing.

As used herein, “photocured” refers to a material or composition that has been hardened or partially hardened using actinic radiation.

As used herein, “integral” refers to being made at the same time or being incapable of being separated without damaging one or more of the (integral) parts.

As used herein, “liquid” refers to the state of matter that is not solid or gas, which has a definite volume and an indefinite shape. Liquids encompass emulsions, dispersions, suspensions, solutions, and pure components, and exclude (e.g., solid) powders and particulates.

As used herein, “sol” refers to a continuous liquid phase containing discrete particles having sizes in a range from 1 nanometer (nm) to 100 nm.

As used herein, “slurry” refers to a continuous liquid phase containing discrete particles having sizes in a range from greater than 100 nm to 50 micrometers or from greater than 100 nm to 10 micrometers. A slurry may optionally further contain discrete particles having sizes in a range from 1 nanometer (nm) to 100 nm.

As used herein, “ceramic” and “ceramic article” include amorphous material, glass, crystalline ceramic, glass-ceramic, and combinations thereof, and refers to non-metallic materials produced by application of heat. Ceramics are usually classified as inorganic materials. The term “amorphous material” refers to material that lacks long range crystal structure as determined by X-ray diffraction and/or has an exothermic peak corresponding to the crystallization of the amorphous material as determined by DTA (differential thermal analysis). The term “glass” refers to amorphous material exhibiting a glass transition temperature. The term “glass-ceramic” refers to ceramics comprising crystals formed by heat-treating amorphous material. The term “crystalline ceramic” refers to a ceramic material exhibiting a discernible X-ray powder diffraction pattern. “Crystalline” means a solid composed of atoms arranged in a pattern periodic in three dimensions (i.e., has long-range crystal structure, which may be determined by techniques such as X-ray diffraction). A “crystallite” means a crystalline domain of a solid having a defined crystal structure. A crystallite can only have one crystal phase. “Semicrystalline” means a material that comprises both an amorphous region and a crystalline region.

As used herein, “ceramic particle” encompasses particles of amorphous material, glass, crystalline ceramic, glass-ceramic, and combinations thereof, and refers to non-metallic materials produced by application of heat or made by a chemical synthesis process. Ceramic particles are usually classified as inorganic materials. The term “amorphous material” with respect to ceramic particles refers to a material derived from a melt and/or a vapor phase as well as a material made from chemical synthesis, wherein the material lacks long range crystal structure as determined by X-ray diffraction and/or has an exothermic peak corresponding to the crystallization of the amorphous material as determined by DTA (differential thermal analysis). For instance, amorphous silica nanoparticles may be generated by condensation of silanes to form the nanoparticles.

As used herein, a “powder” refers to a dry, bulk material composed of a large number of fine particles that may flow freely when shaken or tilted.

As used herein, a “particle” refers to a substance being a solid having a shape which can be geometrically determined. The shape can be regular or irregular. Particles can typically be analyzed with respect to e.g., particle size and particle size distribution. A particle can comprise one or more crystallites. Thus, a particle can comprise one or more crystal phases.

As used herein, “associated” refers to a grouping of two or more primary particles that are aggregated and/or agglomerated. Similarly, the term “non-associated” refers to two or more primary particles that are free or substantially free from aggregation and/or agglomeration.

As used herein, “aggregation” refers to a strong association of two or more primary particles. For example, the primary particles may be chemically bound to one another. The breakdown of aggregates into smaller particles (e.g., primary particles) is generally difficult to achieve.

As used herein, “agglomeration” refers to a weak association of two or more primary particles. For example, particles may be held together by charge or polarity. The breakdown of agglomerates into smaller particles (e.g., primary particles) is less difficult than the breakdown of aggregates into smaller particles.

As used herein, “primary particle size” refers to the size of a non-associated single crystalline or single amorphous ceramic particle, which is considered to be a primary particle. X-ray diffraction (XRD) for crystalline particles and transmission electron microscopy (TEM) for amorphous particles are typically used to measure the primary particle size.

As used herein, “essentially spherical” means that the shape of the particles is close to a sphere. It does not contain sharp edges, which may result from a milling process.

As used herein, “soluble” means that a component (e.g., a solid) can be completely dissolved within a solvent. That is, the substance is able to form individual molecules (like glucose) or ions (like sodium chloride) when dispersed in water at 23° C. The solubilization process, however, might take some time, e.g. stirring the component over a couple of hours (e.g., 10 to 20 hours) might be required.

As used herein, “aerogel” means a three-dimensional low-density solid. An aerogel is a porous material derived from a gel, in which the liquid component of the gel has been replaced with a gas. The solvent removal is often done under supercritical conditions. During this process the network does not substantially shrink and a highly porous, low-density material can be obtained.

As used herein, “xerogel” refers to a three-dimensional solid derived from a gel, in which the liquid component of the gel has been removed by evaporation under ambient conditions or at an elevated temperature.

As used herein, “heat treating”, “calcining”, “binder burn out”, or “debindering” refers to a process of heating solid material to drive off at least 90 percent by weight of volatile chemically bound components (e.g., organic components) (versus, for example, drying, in which physically bonded water is driven off by heating). Heat treating is done at a temperature below a temperature needed to conduct a sintering step.

As used herein, “sintering” and “firing” are used interchangeably. A porous (e.g., pre-sintered) ceramic article shrinks during a sintering step, that is, if an adequate temperature is applied. The sintering temperature to be applied depends on the ceramic material chosen. Sintering typically includes the densification of a porous material to a less porous material (or a material having less cells) having a higher density, in some cases sintering may also include changes of the material phase composition (for example, a partial conversion of an amorphous phase toward a crystalline phase).

As used herein, “architectural void” refers to refers to a void fully encompassed within an article (e.g., does not extend to any exterior surface of the article) and that has a designed shape, such as one programmed into an additive manufacturing device employed to selectively cure the photopolymerizable composition to create a shape of the article. An architectural void is in contrast to an internal pore formed during manufacture of the article

As used herein, “particle” refers to a substance being a solid having a shape which can be geometrically determined. The shape can be regular or irregular. Particles can typically be analyzed with respect to e.g., particle size and particle size distribution. A particle can comprise one or more crystallites. Thus, a particle can comprise one or more crystal phases.

As used herein, “polymerizable composition” means a hardenable composition that can undergo polymerization upon initiation (e.g., free-radical polymerization initiation). Typically, prior to polymerization (e.g., hardening), the polymerizable composition has a viscosity profile consistent with the requirements and parameters of one or more 3D printing systems. In some embodiments, for instance, hardening comprises irradiating with actinic radiation having sufficient energy to initiate a polymerization or cross-linking reaction. For instance, in some embodiments, ultraviolet (UV) radiation, e-beam radiation, or both, can be used. When actinic radiation can be used, the polymerizable composition is referred to as a “photopolymerizable composition”.

As used herein, a “resin” contains all polymerizable components (monomers, oligomers and/or polymers) being present in a hardenable composition. The resin may contain only one polymerizable component compound or a mixture of different polymerizable compounds.

As used herein, “solvent” refers to a nonreactive liquid component of a composition that dissolves at least one solid component, or dilutes at least one liquid component, of the composition (in the case of water, adventitious amounts of water are not included by the term “solvent”).

As used herein, “solid” refers to a state of matter that is solid at one atmosphere of pressure and at least one temperature in the range of from 20-25° C., inclusive, (as opposed to being in a gaseous or liquid state of matter).

As used herein, “thermoplastic” refers to a polymer that flows when heated sufficiently above its glass transition point and become solid when cooled.

As used herein, “thermoset” refers to a polymer that permanently sets upon curing and does not flow upon subsequent heating. Thermoset polymers are typically crosslinked polymers.

The present disclosure provides additive manufactured articles, methods of making the articles, and kits. Advantageously, the articles, even when very small, are readily manipulated by a user.

In a first aspect, an additive manufactured article is provided. The article comprising a first portion and a second portion integral to the first portion, wherein the second portion comprises a coupling configured to engage a tool, and wherein the second portion comprises a frangible section at a connection point to the first portion.

In a second aspect, a method of making an additive manufactured article is provided. The method comprises:
a) obtaining a photopolymerizable material; and
b) selectively curing the photopolymerizable material to form an additive manufactured article comprising a first portion and a second portion integral to the first portion, wherein the second portion comprises a coupling configured to engage a tool, and wherein the second portion comprises a frangible section at a connection point to the first portion.

In a third aspect, a kit is provided. The kit comprises:
a) an additive manufactured article comprising a first portion and a second portion integral to the first portion, wherein the second portion comprises a coupling configured to engage a tool, and wherein the second portion comprises a frangible section at a connection point to the first portion; and
b) a tool configured to attach to the coupling.

The below disclosure relates to each of the first through third aspects.

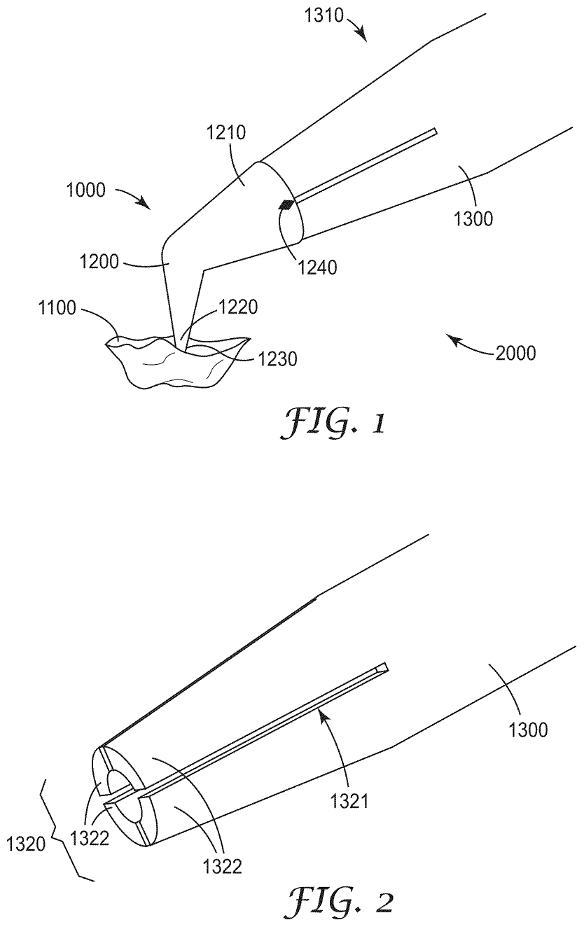

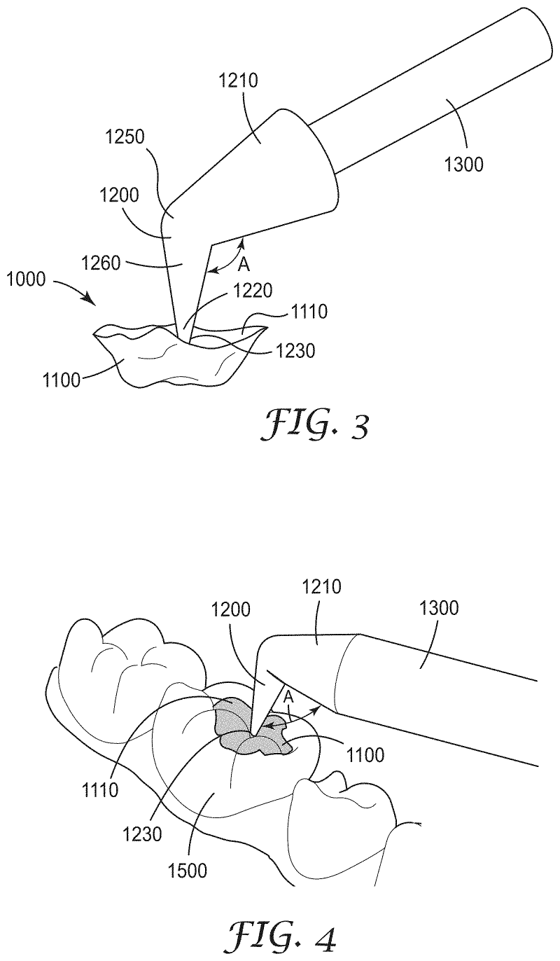

Referring to FIGS. 1 and 3, schematic perspective views are provided of exemplary additive manufactured articles 1000 according to the present disclosure. Each article 1000 comprises a first portion 1100 and a second portion 1200 integral to the first portion 1100. The second portion 1200 comprises a coupling 1210 engaged with a tool 1300. The second portion 1200 further comprises a frangible section 1220 at a connection point 1230 to the first portion 1100. In these illustrated embodiments, the coupling 1210 comprises a conical shape, and the portion having the conical shape is configured to receive the tool 1300. Other useful shapes for the frangible section include for instance, pyramidal, stepped cylinders, and branches cascading from smaller numbers and larger diameters to greater numbers and smaller diameters, wherein the smallest diameter branches are frangible

Referring to FIG. 2, a schematic perspective view is provided of an exemplary tool 1300 configured to engage with the coupling of an article via a connection 1320. The mechanism for attaching a tool to an article is not particularly limited, and may include for instance, attachment by a slit and beam connection, a clamp connection, a screw and thread connection, a snap connection, a bolt connection, a friction fit connection, or a pressure sensitive adhesive connection. The tool 1300 of the embodiment in FIG. 2 is shaped for a slit and beam connection 1320 with the coupling of an article. For instance, the open end of the tool 1300 defines four slits 1321, equally spaced radially at 90 degree intervals (other frequencies may also be useful). The purpose of the slits is to create four cantilevered beams 1322, which are used to clamp tight against an interior surface of the coupling when inserted into the open end of the coupling 1210 of the article. To provide a clamping effect, the inside diameter of the coupling 1210 opening in its relaxed state (i.e., no tool inserted) should be slighter smaller than the outside diameter of the tool 1300.

FIG. 1 also shows a kit 2000 comprising the article 1000 and the tool 1300, which is attached to the article 1000. Kits according to the present disclosure are contemplated to contain any article described herein. The tool 1300 often comprises a handle 1310 for a user to be able to manipulate the article 1000 using the tool 1300. Optionally, the article 1000 further comprises a fiducial marker 1240 integral to the second portion 1200. A fiducial marker 1240 may be designed to indicate a preferred alignment of an article 1000 with respect to a tool 1300.

Additive manufacturing allows for extensive design freedom in configuring an article, including incorporating an angle between the coupling and the first portion to provide convenient orientation of the first portion with respect to a tool for manipulating the article. Regarding any article 1000 described above, the second portion 1200 optionally forms an angle A between the coupling 1210 and the connection point 1230 to the first portion 1100 of 45 degrees or greater, 50 degrees or greater, 55 degrees or greater, 60 degrees or greater, 65 degrees or greater, 70 degrees or greater, 75 degrees or greater, 80 degrees or greater, 85 degrees or greater, 90 degrees or greater, 95 degrees or greater, 100 degrees or greater; and 180 degrees or less, 175 degrees or less, 170 degrees or less, 165 degrees or less, 160 degrees or less, 155 degrees or less, 150 degrees or less, 145 degrees or less, 140 degrees or less, 135 degrees or less, 130 degrees or less, 125 degrees or less, 120 degrees or less, 115 degrees or less, 110 degrees or less, or 105 degrees or less. Stated another way, the second portion 1200 may form an angle A ranging from 45 degrees to 180 degrees between the coupling 1210 and the connection point 1230 to the first portion 1100.

Regarding any article described above, the first portion may favorably have a shape of a dental restoration or an orthodontic appliance. The dental restoration may be selected from a crown, a bridge, an inlay, an onlay, a veneer, a facing, or a coping. The orthodontic appliance may be selected from an attachment (e.g., for use with a clear tray aligner (CTA)), a bracket, a buccal tube, a hook, or a button. In the embodiments of FIGS. 1, 3-6A, and 7, the article 1000 comprises a custom dental inlay. The inlay is designed to fill a cavity in a lower right first molar. Integrally attached to an occlusal surface 1110 of the inlay is a second portion 1200 comprising a conical coupling 1210. Joined thereto is a spherical elbow 1250, another conical segment 1260, and a cylindrical tool 1300 comprising a handle 1310 for holding and manipulation by a clinical practitioner (e.g., a dentist). The assembly of the article 1000 and the tool 1300 is designed such that the handle 1310 is oriented to be easily accessible from a patient's mouth. In terms of an arch coordinate system, the handle orientation can include two vector components: (1) an altitude or elevation angle above (or below) the occlusal plane of the arch, and (2) an azimuth angle or “compass heading” relative to the midsagittal plane of the arch. The angle A is optionally derived geometrically from both the coupling orientation and the first portion orientation in arch coordinates. Although the frangible section 1220 might generally be placed in a vertical orientation, it can just as well be placed in some other orientation for purposes of avoiding interference with features of the dental anatomy, or to ease insertion of the first portion 1100 (e.g., inlay) into the receiving cavity of the tooth 1500.

Referring to FIGS. 4-6A, an article 1000 may comprise an inlay shaped to fill a cavity prepared in the fossa of a posterior tooth 1500. FIG. 4, for instance, provides an oblique occlusal view of a lower right first molar 1500 with a dental inlay as the first portion 1100 inserted into a prepared cavity using a placement tool 1300 attached to the second portion 1200 of the article 1000. The inlay of the first portion 1100 may be bonded in place using dental adhesive (e.g., 3M FILTEK Supreme Ultra Flowable Restorative or SCOTCHBOND Universal adhesive, both commercially available from 3M Company (St. Paul, Minn.)), which may be a light-cure adhesive, a chemical cure adhesive, or a dual cure adhesive, such as 3M RELYX Ultimate Adhesive Resin Cement commercially available from 3M Company (St. Paul, Minn.). The chosen adhesive must be sufficiently compatible with the material used to fabricate the first portion 1100 to securely bond the first portion into the tooth 1500. It is noted that relatively low viscosity, unfilled resins may be preferable for custom dental restorations that are designed to fit precisely onto or into a prepared tooth surface, particularly when there is a small tolerance between the tooth surface and the bonded surface of the dental restoration.

The second portion 1200 comprises a frangible section 1220 extending from the occlusal surface 1110 of the first portion 1100 (e.g., inlay). As such, the second portion 1200 would be shaped and oriented so as not to interfere with the bonding surfaces of the first portion 1100 or the features of the restored tooth 1500 or any surrounding teeth. The second portion 1200 is designed to be strong enough to guide the first portion 1100 into position and press it into the receiving cavity of the tooth 1500 without it breaking. Conversely, the frangible section 1220 of the second portion 1200 is designed with a connection point 1230 very near the surface of the first portion 1100 (e.g., inlay) intended to fracture so that the second portion 1200 may be broken away cleanly after the first portion 1100 is bonded into place. The second portion 1200 comprises a coupling 1210 designed to extend enough to mate with a separate tool 1300 (e.g., a hand instrument) which is used for this task. The coupling 1210 and the tool 1300 are designed such that the coupling 1210 remains securely engaged with the tool 1300 after separation from the first portion 1100 (e.g., inlay) until the second portion 1200 is safely removed from the patient's mouth.

In select embodiments, the connection point between the frangible section and the first portion may be recessed below the clinical surface of the dental restoration in a depression, cup, divot, or other such cavity, so that any residual frangible section material left sticking up from the surface of the first portion, e.g., due to the fracture point being displaced from the surface, is actually at or below the clinical surface of the dental restoration. This feature would eliminate the need for material removal after bonding, such as by using abrasive materials, but would optionally require the use of a light-cured filling material, such as 3M FILTEK Universal Restorative or 3M FILTEK One Bulk Fill Restorative (both commercially available from 3M Company (St. Paul, Minn.)). For a first portion that has a hard ceramic surface, this may be particularly advantageous to minimize a need for grinding and/or polishing of the first portion.

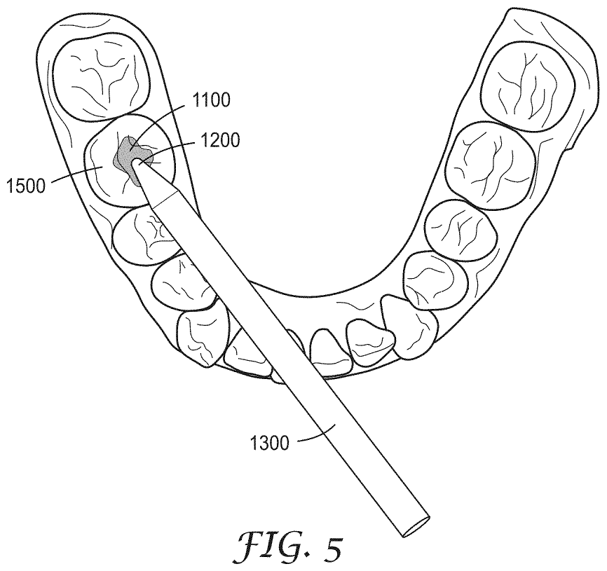

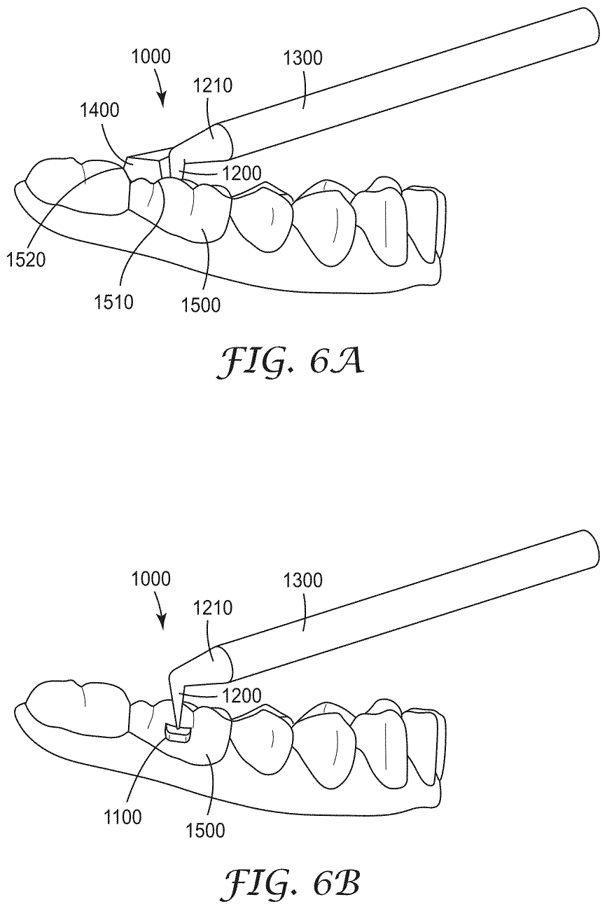

FIGS. 5 and 6A provide additional views of the scenario of FIG. 4, thus providing additional context and a sense of the length, position, and orientation of a tool 1300 relative to the patient's mouth. The tool 1300 is preferably designed to be accessible from the anterior aspect of the arch, and a significant angle of inclination above the mandibular occlusal plane is incorporated into the handle 1310 of the tool 1300, to give the practitioner some room to grip the handle 1310 without his or her fingers interfering with the teeth in the lower arch. Similarly, the handle 1310 is oriented from an occlusal aspect such that its midsection is directed away from the patient's cheek (toward the midline), thereby allowing the practitioner some room to grip the handle 1310 without interference from the patient's oral mucosa. An additional consideration is designing for minimal interference in the event of the patient partially closing his or her mouth at a moment when the practitioner is either not holding or lightly holding the handle 1310. This could possibly happen at a time when the adhesive is partially cured, and a nudge to the tool handle 1310 could cause the first portion 1100 (e.g., inlay) to move to an improper position before being fully cured. It may thus be advantageous to position the handle 1310 for minimal applied force from partially closed lips and cheeks.

Articles according to the present disclosure can be particularly advantageous when preparing small articles that may be difficult to handle due to their limited size, e.g., using a tool such as tweezers. Regarding any article described above, the first portion optionally has a maximum dimension of 30 millimeters (mm) or less, 28 mm or less, 26 mm or less, 24 mm or less, 22 mm or less, 20 mm or less, 18 mm or less, 16 mm or less, 14 mm or less, 12 mm or less, 10 mm or less, 8 mm or less, 6 mm or less, or 4 mm or less; and 0.25 mm or greater, 0.50 mm or greater, 0.75 mm or greater, 1.00 mm or greater, 1.25 mm or greater, 1.50 mm or greater, 1.75 mm or greater, 2.00 mm or greater, 2.50 mm or greater, 3.00 mm or greater, or 3.50 mm or greater.

The frangible section is generally designed to concentrate stress at the junction between the second portion and the first portion when lateral bending forces are applied. Typically, the frangible section has a minimum dimension of 50 micrometers or larger, 75 micrometers or larger, or 100 micrometers or larger; and 1 mm or less. In some embodiments, a minimum dimension may be limited by the capabilities of a particular additive manufacturing method used to form the article. The skilled practitioner can determine a size and shape of the frangible section that imparts sufficient structural integrity to allow handling of the article while also breaking easily when desired. Stress is concentrated by virtue of the frangible section having a minimum cross-sectional area at this junction and there being an abrupt increase in area at a surface of the first portion. The frangible section may be broken by using a tool handle as a lever to bend the second portion in any off-axis direction. If an elbow is incorporated into the tool, the frangible section could be bent or sheared by twisting the handle about its axis. The frangible section could be sheared by pushing or pulling along the axis of the tool handle, or by sweeping the tool handle laterally. In any case, a small burr of nub may be left on the first portion at the connection point, which is easily removed using any variety of high speed cutting and/or polishing tools.

Regarding any of the articles described above, additional useful features may be incorporated into the article. For instance, referring to FIG. 6A, this embodiment of an article 1000 further comprises a third portion 1400 integral to the second portion 1200. The third portion 1400 advantageously has a registration shape for the first portion 1100. In this embodiment, the registration shape of the third portion 1400 is a shape that is complementary to a shape of an occlusal surface 1510 of a portion of the tooth on which the inlay is designed to be inserted and a shape of an occlusal surface 1520 of a portion of a directly adjacent tooth. Hence, as the article 1000 is inserted into a mouth of a patient, the third portion 1400 readily fits a surface area adjacent to a small receiving cavity in which the first portion (e.g., an inlay) is designed to fit, assisting a clinical practitioner to correctly orient the first portion with respect to the tooth. Other registration shapes that provide guidance for placement of the first portion of an article may be designed based on features in the vicinity of the desired placement. In other embodiments, the registration shape is instead complementary to a shape of one or more other surfaces, such as the labial surface, the buccal surface, and/or the lingual surface of a tooth. The registration shape may be designed to interface with one surface or optionally two or more surfaces on a tooth or multiple teeth, e.g., in an embodiment the registration feature may partially or fully surround a perimeter of the first portion and be offset by a distance sufficient to remain clear of any excess adhesive and to allow for deformation of the frangible portion sufficient to break it.

Referring to FIG. 6B, an exemplary article 1000 is shown. The article 1000 comprises a first portion 1100 having a shape of an attachment (e.g., an orthodontic appliance). The second portion 1200 of the article 1000 is engaged with a tool 1300 via a coupling 1210, and the first portion 1100 is shown being placed on a buccal surface of a tooth 1500.

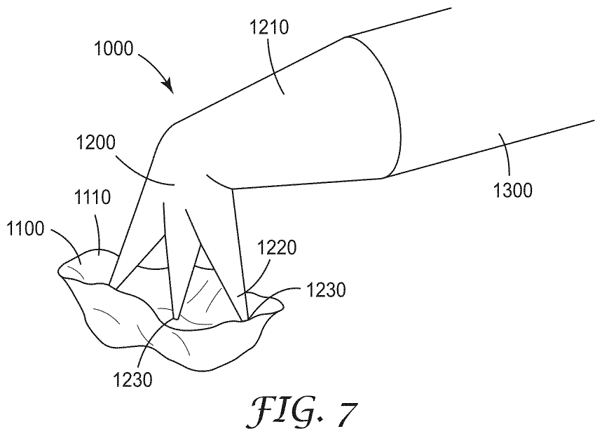

Referring to FIG. 7, in this embodiment of an article 1000 the frangible section 1220 comprises at least two connection points 1230 to the first portion 1100, for instance three connection points 1230. The frangible sections 1220 join the occlusal surface 1110 of the first portion 1100 at various connection points 1230 and join the coupling 1210 at a common intersection point, the center of the elbow 1250 between the frangible section 1220 and the coupling 1210. It may be advantageous to use more than one connection point for larger articles and/or to increase the robustness of the article during fabrication and handling, thereby preventing premature breakage of the frangible sections, thus more than one connection point may be incorporated into any of the articles described above if desired.

In embodiments in which the article comprises a dental restoration, after cleaning and preparing the restoration, the bonding surfaces of the restoration and/or the tooth are coated with an appropriate adhesive or dental cement. In the case of a chemically cured adhesive, one part is applied to the patient's prepared dental anatomy, and the other part is applied to the restoration. A chemical reaction that results in hardening, or curing, takes place as the two chemicals come into contact, initiated by the restoration being placed into its final position in the patient's dental anatomy. In the case of a radiation cured adhesive, the adhesive is applied to either the patient's prepared dental anatomy or the restoration. The adhesive is cured by exposure to actinic radiation (e.g., UV or blue light) for several seconds. It may be necessary to subsequently remove excess cured adhesive or “flash” using one or more abrasive dental instruments, such as burs or polishers.

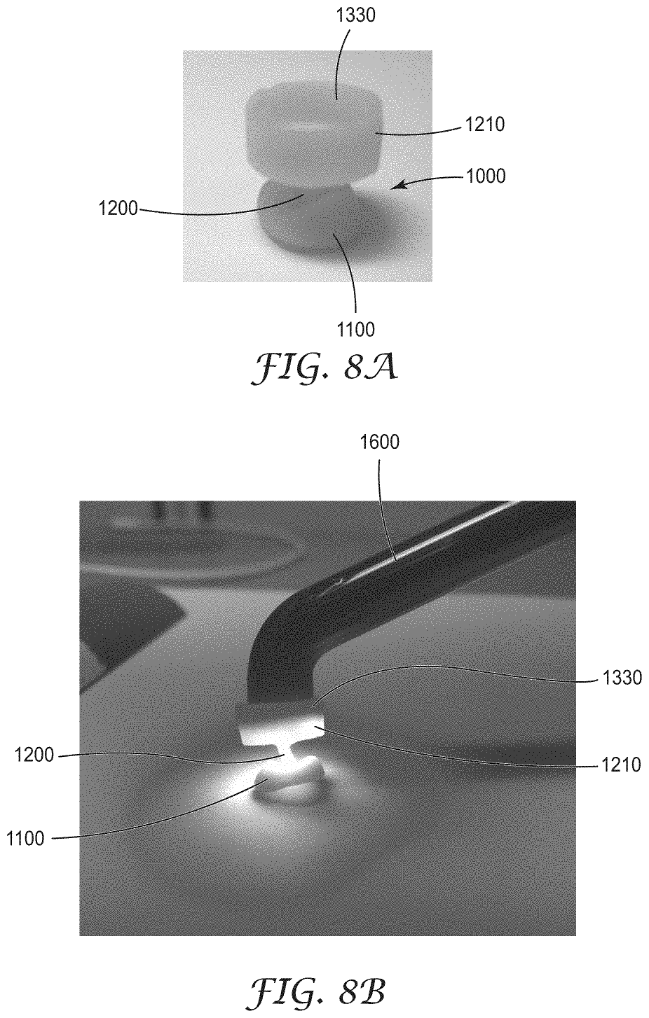

Regarding any article described above that may be adhered using a radiation cured adhesive, the article may be configured to facilitate use of a radiation source. For instance, referring to FIGS. 8A and 8B, in this embodiment an article 1000 further comprises a light guide 1600 removably attached to the second portion 1200. More particularly, in this embodiment, the light guide 1600 is engaged with the coupling 1210 of the second portion 1200 of the article 1000 via a friction fit connection 1330. Favorably, the light guide 1600 often comprises an actinic radiation source. As seen in FIG. 8B, the article 1000 transmits a visually obvious amount of light through both the second portion 1200 and the first portion 1100 (e.g., an onlay). In certain embodiments, the second portion 1200 can be formed to have a different color than the first portion, even if the materials are the same (e.g., a color more transparent to the actinic radiation than whatever color is needed for the first portion 1100). Advantageously, the first portion 1100 can first be placed with one hand in a prepared location in a patient's mouth and exposed to actinic radiation from the light guide 1600 to set the first portion 1100. Then the second portion 1200 of the article 1000 can be removed by breaking the frangible portion 1220. Optionally, the clinical practitioner can follow up with additional curing (e.g., exposing the first portion 1100 to another dose of light after the removal of the second portion 1200). It is contemplated that the article could be configured such that the light guide is disposed adjacent to the coupling instead of engaged with the coupling. In such embodiments, known dimensions of commercially available light guides would be available to allow design of the article to additively manufacture a suitable connection between the article and the light guide. Regarding any light guide described above, favorably the second portion may be coated with a photoreflective material, e.g., a metal vapor deposition coating, an electroplated coating, or a dipcoating of metallic material. Use of a photoreflective material may advantageously assist in directing light from the light guide to a photocurable adhesive bonding the first portion to a patient's dental anatomy or an indirect bonding tray.

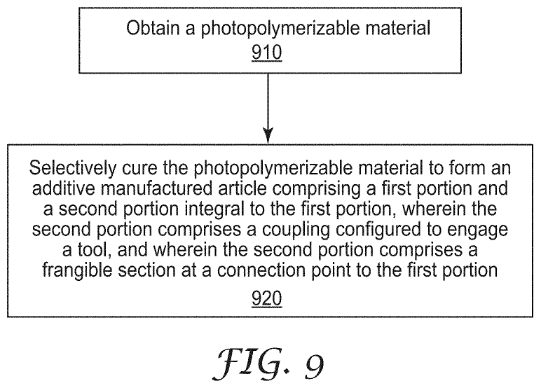

Referring to FIG. 9, a generalized flow chart is provided of a process of making an additive manufactured article. In particular, the process includes the steps of obtaining a photopolymerizable material 910; selectively curing the photopolymerizable material to form an additive manufactured article comprising a first portion and a second portion integral to the first portion, wherein the second portion comprises a coupling configured to engage a tool, and wherein the second portion comprises a frangible section at a connection point to the first portion 920.

Regarding any article described above, the first portion, the second portion, or both, of the article is formed of a ceramic material, a polymeric material, a polymer composite, or a combination thereof. Suitable materials for use in additive manufacturing of articles are described in detail, for instance in International PCT Publications WO 2019/048963 (Parkar et al.), WO 2018/231583 (Herrmann et al.), WO 2016/191534 (Mayr et a.), WO 2016/191162 (Mayr et a.), and WO 2014/078537 (Sun et al). For instance, suitable materials for use when the photopolymerizable material is a sol or slurry are described in detail below. Moreover, the first portion and the second portion can be formed of the same material or can be formed of different materials. For example, a photopolymerizable material used to form the article optionally comprises a first composition and a second composition and making an article includes selectively curing the first composition to form the first portion of the article and selectively curing the second composition to form the second portion of the article. In some favored embodiments, the first portion is formed of a material that has a higher ultimate strength than a material of which the frangible section is formed. This is preferable when the first portion comprises a dental restoration, which typically requires a high ultimate strength.

Methods of printing a three-dimensional article described herein can include forming the article from a plurality of layers of a photopolymerizable material described herein by selectively curing the photopolymerizable material in a layer-by-layer manner. In such embodiments, the article comprises a plurality of materials bonded to each other. Further, the layers of a build material composition can be deposited according to an image of the three-dimensional article in a computer readable format. In some or all embodiments, the photopolymerizable composition is deposited according to preselected computer aided design (CAD) parameters (e.g., a data file). Typically, the photopolymerizable composition is cured using actinic radiation comprising UV radiation, e-beam radiation, visible radiation, or a combination thereof.

Additionally, it is to be understood that methods of manufacturing a 3D article described herein can include so-called “stereolithography/vat polymerization” 3D printing methods. It is entirely possible to form a 3D article from a photopolymerizable composition described herein using vat polymerization (e.g., stereolithography). For example, in some cases, a method of printing a 3D article comprises retaining a photopolymerizable composition described herein in a fluid state in a container and selectively applying energy to the photopolymerizable composition in the container to solidify at least a portion of a fluid layer of the photopolymerizable composition, thereby forming a hardened layer that defines a cross-section of the 3D article. Additionally, a method described herein can further comprise raising or lowering the hardened layer of photopolymerizable composition to provide a new or second fluid layer of unhardened photopolymerizable composition at the surface of the fluid in the container, followed by again selectively applying energy to the photopolymerizable composition in the container to solidify at least a portion of the new or second fluid layer of the photopolymerizable composition to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the photopolymerizable composition. Moreover, selectively applying energy to the photopolymerizable composition in the container can comprise applying actinic radiation, such as UV radiation, visible radiation, or e-beam radiation, having a sufficient energy to cure the photopolymerizable composition. A method described herein can also comprise planarizing a new layer of fluid photopolymerizable composition provided by raising or lowering an elevator platform. Such planarization can be carried out, in some cases, by utilizing a wiper or roller or a recoater. Planarization corrects the thickness of one or more layers prior to curing the material by evening the dispensed material to remove excess material and create a uniformly smooth exposed or flat up-facing surface on the support platform of the printer.

It is further to be understood that the foregoing process can be repeated a selected number of times to provide the 3D article. For example, in some cases, this process can be repeated “n” number of times. Further, it is to be understood that one or more steps of a method described herein, such as a step of selectively applying energy to a layer of photopolymerizable composition, can be carried out according to an image of the 3D article in a computer-readable format. Suitable stereolithography printers include the Viper Pro SLA, available from 3D Systems, Rock Hill, S.C. and the Asiga PICO PLUS 39, available from Asiga USA, Anaheim Hills, Calif.

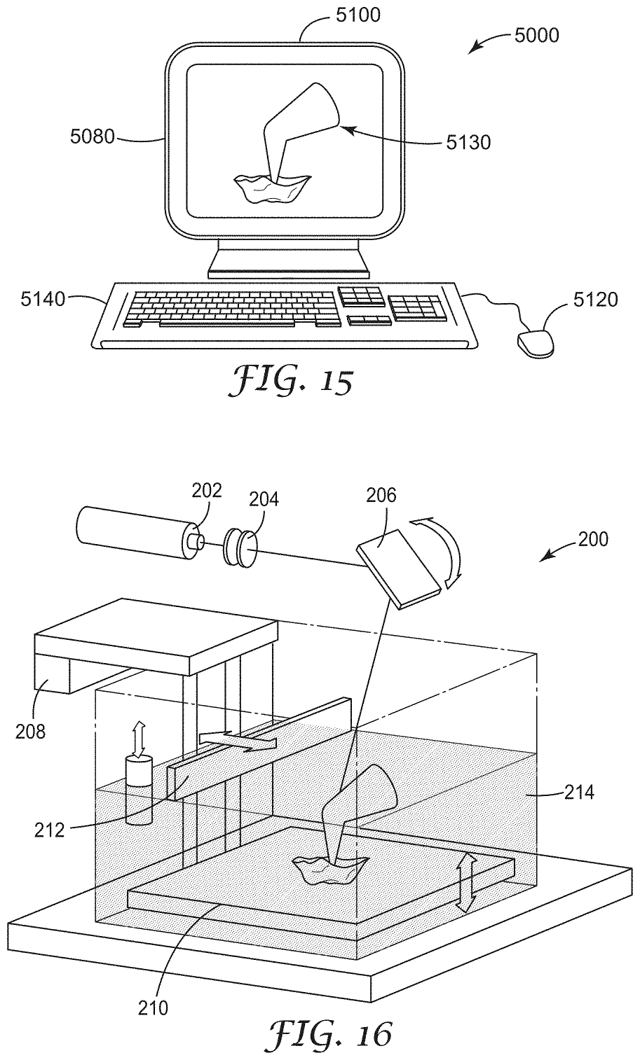

FIG. 16 shows an exemplary stereolithography apparatus (“SLA”) that may be used with the photopolymerizable compositions and methods described herein. In general, the SLA 200 may include a laser 202, optics 204, a steering lens 206, an elevator 208, a platform 210, and a straight edge 212, within a vat 214 filled with the photopolymerizable composition. In operation, the laser 202 is steered across a surface of the photopolymerizable composition to cure a cross-section of the photopolymerizable composition, after which the elevator 208 slightly lowers the platform 210 and another cross section is cured. The straight edge 212 may sweep the surface of the cured composition between layers to smooth and normalize the surface prior to addition of a new layer. In other embodiments, the vat 214 may be slowly filled with liquid resin while an article is drawn, layer by layer, onto the top surface of the photopolymerizable composition.

A related technology, vat polymerization with Digital Light Processing (“DLP”), also employs a container of curable polymer (e.g., photopolymerizable composition). However, in a DLP based system, a two-dimensional cross section is projected onto the curable material to cure the desired section of an entire plane transverse to the projected beam at one time. All such curable polymer systems as may be adapted to use with the photopolymerizable compositions described herein are intended to fall within the scope of the term “vat polymerization system” as used herein.

Other techniques for three-dimensional manufacturing are known, and may be suitably adapted to use in the applications described herein. More generally, three-dimensional fabrication techniques continue to become available. All such techniques may be adapted to use with photopolymerizable compositions described herein, provided they offer compatible fabrication viscosities and resolutions for the specified article properties, for instance continuous additive manufacturing in which a build plate is (essentially) continuously moved through a vat of photopolymerizable material. For example, fused deposition modeling (FDM), stereolithography, selective laser sintering (SLS), multiphoton polymerization, binderjet printing, inkjet printing, and/or polyjet printing could all be suitable methods for manufacturing the article. In certain embodiments, an apparatus adapted to be used in a continuous mode may be employed, such as an apparatus commercially available from Carbon 3D, Inc. (Redwood City, Calif.), for instance as described in U.S. Pat. Nos. 9,205,601 and 9,360,757 (both to DeSimone et al). For example, in any method described above, selective curing of a photopolymerizable material comprises continuous photopolymerization of at least one of the first portion of the article or the second portion of the article.

Fabrication may be performed using any of the fabrication technologies described herein, either alone or in various combinations, using data representing a three-dimensional object, which may be reformatted or otherwise adapted as necessary for a particular printing or other fabrication technology.

After an article has been formed, it is typically removed from the additive manufacturing apparatus. At this stage, the three-dimensional article typically has sufficient green strength for handling in any remaining steps of the method. The article surface, as well as the bulk article itself, typically still retain uncured material, suggesting a need for further curing. Removing residual uncured photopolymerizable material is particularly useful when the article is going to subsequently be post-cured, to minimize uncured residual material from undesirably curing directly onto the article. A “cured” article can comprise a photopolymerizable material that has been at least partially polymerized and/or crosslinked. For instance, in some instances, an at least partially polymerized article is at least about 10% polymerized or crosslinked or at least about 30% polymerized or crosslinked. In some cases, an at least partially polymerized article is at least about 50%, at least about 70%, at least about 80%, or at least about 90% polymerized or crosslinked, for instance between about 10% and about 99% polymerized or crosslinked.

In some embodiments, removal of excess uncured photopolymerizable composition on the additive manufactured article is at least partially performed by washing with at least one solvent. Suitable solvents include, for instance and without limitation, includes propylene carbonate, isopropanol, methanol, di(ethylene glycol) ethyl ether, tripropylene glycol monomethyl ether, diethylene glycol monobutyl ether, a blend of dipropylene glycol monomethyl ether with [2-(2-methoxymethylethoxy)methylethoxy]propanol, and combinations thereof. In certain embodiments, the removal is performed at least partially by moving the additive manufactured article and thereby generating a mass inertial force in uncured photopolymerizable composition on the article, wherein the mass inertial force is generated using a centrifuge, a shaker, or a mixer that spins along one or more axes. Suitable ways of generating a mass inertial force are described, for instance, in co-owned International Publication No. WO 2020/157598 (Chakraborty et al.), incorporated herein by reference in its entirety. For instance, the source of the mass inertial force may be generated using a centrifuge, a shaker, or a mixer that spins along one or more axes. In some embodiments, the moving of the object is a rotation or spinning of the object. Accordingly, the mass inertial force may be generated by a centrifugal force. One suitable mixer that spins along more than one axis is a dual asymmetric centrifugal mixer, such as the DAC 400 FVZ available from Flacktek, Landrum, S.C. A dual asymmetric centrifugal mixer provides simultaneous dual axis spinning that automatically reorients the article during spinning, which tends to pull uncured composition out of concave features of the article in a short period of time (e.g., 20, 15, or 10 seconds or less).

The method of any embodiment described above may favorably further comprise subjecting the additive manufactured article to actinic radiation, heat, or both to photopolymerize uncured photopolymerizable composition. Optionally, that can be followed by soaking the article with another solvent (e.g., diethylene glycol ethyl ether or ethanol). Exposure to actinic radiation can be accomplished with any convenient radiation source, generally UV radiation, visible radiation, and/or e-beam radiation, for a time ranging from about 10 seconds to over 60 minutes. Heating is generally carried out at a temperature in the range of about 35-80° C., for a time ranging from about 10 to over 60 minutes in an inert atmosphere. So called post-cure ovens, which combine UV radiation and thermal energy, are particularly well suited for use in the post-cure process(es). In general, post curing improves the mechanical properties and stability of the three-dimensional article relative to the same three-dimensional article that is not post cured.

In some embodiments, the photopolymerizable material comprises a ceramic material (e.g., ceramic particles and/or ceramic fibers), and the method further comprises burning out polymerized material and sintering the additive manufactured article to form a ceramic article.

Regarding any method described above, the steps further optionally comprise polishing the additive manufactured article, to render at least a portion of a surface of the additive manufactured article smoother than prior to the polishing.

Data representing an article may be generated using computer modeling, such as computer aided design (CAD) data. Image data representing the article design can be exported in STL format, or in any other suitable computer processable format, to the additive manufacturing equipment. Scanning methods to scan a three-dimensional object may also be employed to create the data representing the article. One exemplary technique for acquiring the data is digital scanning Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al). The initial digital data set, which may include both raw data from scanning operations and data representing articles derived from the raw data, can be processed to segment an article design from any surrounding structures (e.g., a support for the article).

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to computer, such as another networked computer. Referring to FIG. 15, a computing device 1000 often includes an internal processor 5080, a display 5100 (e.g., a monitor), and one or more input devices such as a keyboard 5140 and a mouse 5120. In FIG. 15, an article 5130 is shown on the display 5100.

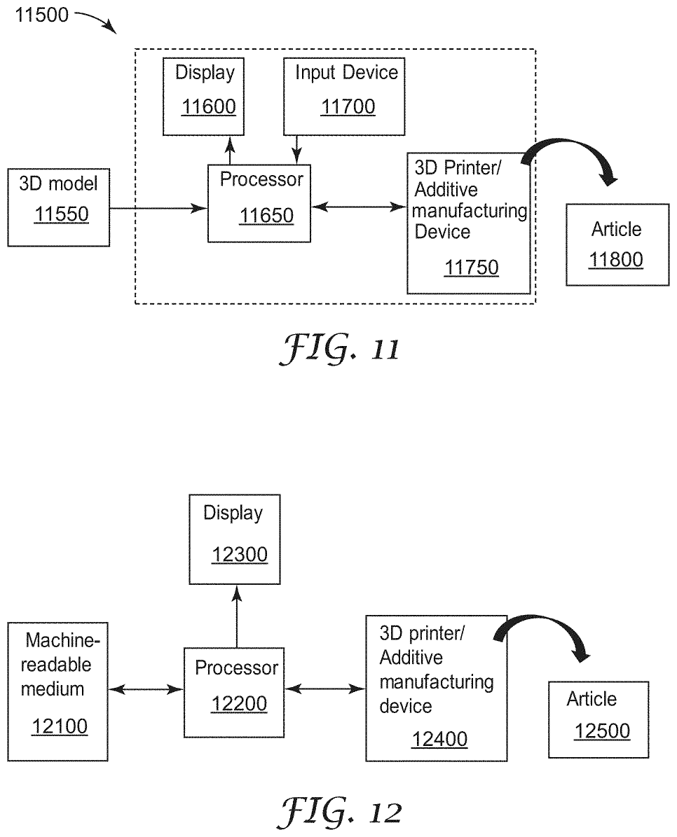

Referring to FIG. 11, in certain embodiments, the present disclosure provides a system 1150. The system 11500 comprises a display 11600 that displays a 3D model 11550 of an article (e.g., an article 5130 as shown on the display 5100 of FIG. 15); and one or more processors 11650 that, in response to the 3D model 11550 selected by a user, cause a 3D printer/additive manufacturing device 11750 to create a physical object of the article 11800. Often, an input device 11700 (e.g., keyboard and/or mouse) is employed with the display 11600 and the at least one processor 11650, particularly for the user to select the 3D model 11550. The article 11800 comprises a first portion and a second portion integral to the first portion, wherein the second portion comprises a coupling configured to engage a tool, and wherein the second portion comprises a frangible section at a connection point to the first portion.

Referring to FIG. 12, a processor 12200 (or more than one processor) is in communication with each of a machine-readable medium 12100 (e.g., a non-transitory medium), a 3D printer/additive manufacturing device 12400, and optionally a display 12300 for viewing by a user. The 3D printer/additive manufacturing device 12400 is configured to make one or more articles 12500 based on instructions from the processor 12200 providing data representing a 3D model of the article 12500 (e.g., an article 5130 as shown on the display 5100 of FIG. 15) from the machine-readable medium 12100.

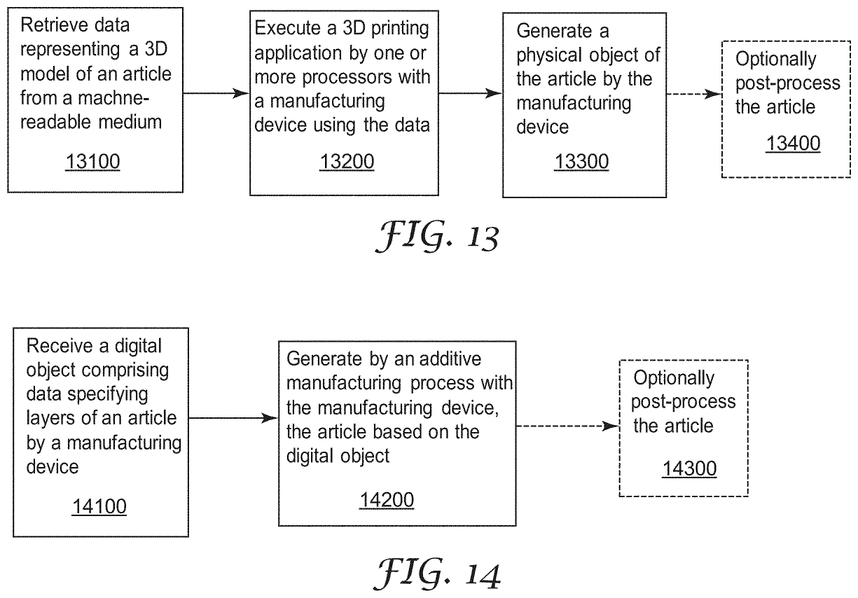

Referring to FIG. 13, for example and without limitation, an additive manufacturing method comprises retrieving 13100, from a (e.g., non-transitory) machine-readable medium, data representing a 3D model of an article according to at least one embodiment of the present disclosure. The method further includes executing 13200, by one or more processors, an additive manufacturing application interfacing with a manufacturing device using the data; and generating 13300, by the manufacturing device, a physical object of the article. One or more various optional post-processing steps 13400 may be undertaken. Typically, the article is at least cleaned with solvent and dried, plus may further be heat treated and/or sintered.

Additionally, referring to FIG. 14, a method of making an article comprises receiving 14100, by a manufacturing device having one or more processors, a digital object comprising data specifying an article; and generating 14200, with the manufacturing device by an additive manufacturing process, the article based on the digital object. Again, the article may undergo one or more steps of post-processing 14300.

In a fourth aspect, another method is provided. The method comprises:

a) obtaining a digital three-dimensional model of a patient's dental anatomy comprising a tooth in need of restoration; and

b) computing a digital three-dimensional model of a dental restoration to fit within the patient's dental anatomy, the dental restoration comprising a first portion and a second portion integral to the first portion, wherein the second portion comprises a coupling configured to engage a tool, wherein the computing comprises determining a shape of the dental restoration.

In some favored embodiments, the method further includes preparing the patient's dental anatomy for a dental restoration prior to obtaining the digital three-dimensional model of the patient's dental anatomy. After preparing the cavity by mechanical drilling, the modified dental anatomy is typically scanned using an intraoral scanner, such as the 3M Mobile True Definition Scanner commercially available from 3M Company (St. Paul, Minn.). Alternatively, a physical impression may be taken, and the impression is then digitized either directly (e.g., industrial CT scanning) or indirectly (e.g., pouring a stone cast and then scanning the model using any suitable technology). The 3D scan of the modified dental anatomy is then used as input to design an appropriate restoration. The surfaces of the restoration may be designed either manually, automatically, or semi-automatically using digital restoration design software. The bonding surface may be taken directly from the scan data, and its limits may be defined as the boundary between prepared dental anatomy and preexisting dental anatomy. This boundary can be defined manually by a human technician tracing a closed path around the perceived preparation area. It could also be defined by an artificial intelligence, for instance as described in co-owned Application No. PCT/IB2020/054778 (Gandrud et al).

Advantageously, computing the digital three-dimensional model of a dental restoration may further comprise determining an angle between the first portion of the article and the second portion of the article configured to avoid interference of the second portion (or a tool attached to the second portion) with features of the patient's dental anatomy. In such cases, information regarding the patient's dental anatomy beyond the immediate vicinity of the tooth in need of restoration is of particular relevance (e.g., including other teeth, cheeks, and/or jaw), to design a suitable angle between the first and second portions of the article.

For articles that include a registration shape, the computing favorably also comprises computing a digital three-dimensional model of a third portion integral to the second portion of the article, wherein the third portion has a registration shape for the first portion of the article. Data regarding at least one feature of the patient's dental anatomy in the vicinity of the tooth in need of restoration is needed to design an appropriate registration shape for the article.

Optionally, the method further includes generating, with an additive manufacturing device by an additive manufacturing process, the dental restoration based on the digital three-dimensional model of the dental restoration. In some embodiments, the method further comprises attaching a tool to the coupling of the second portion; placing the first portion of the dental restoration in contact with the patient's dental anatomy or an indirect bonding tray; and separating the second portion from the first portion at a frangible section located at a connection point to the first portion. An indirect bonding tray may be used to place orthodontic appliances in precise, predetermined positions on the teeth of a patient, and are described in detail in e.g., co-owned International Application Publication Nos. WO 2008/118546 (Kim et al.), WO 2006/124263 (Cinader et al.), WO 2008/115657 (Cinader et al.), and WO 2008/115658 (Raby et al).

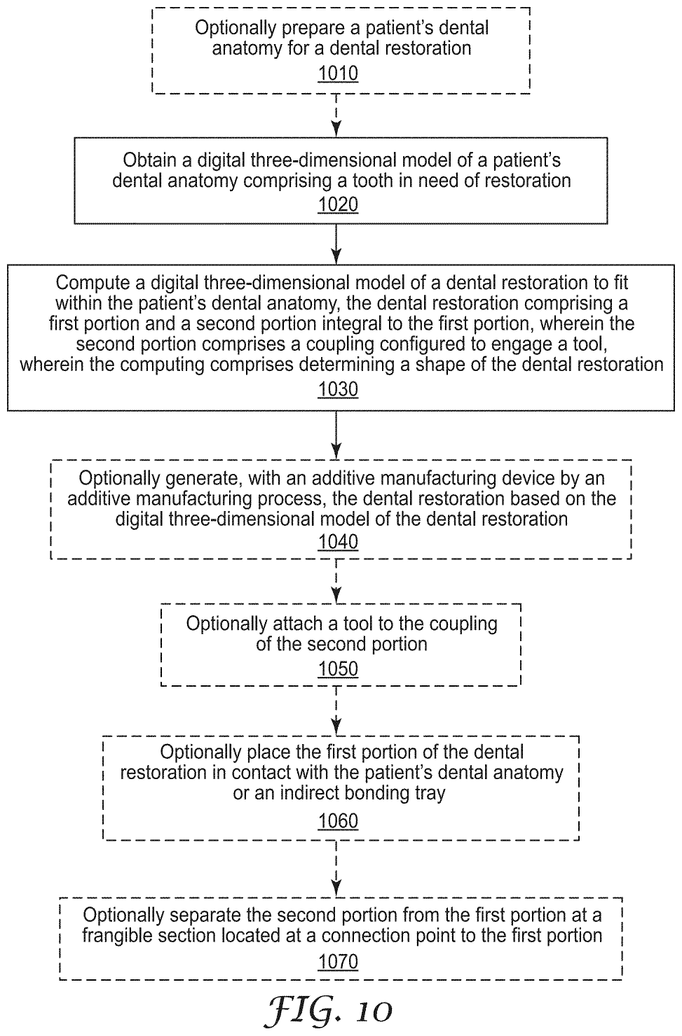

Stated another way, referring to FIG. 10, a generalized flow chart is provided of methods according to the fourth aspect, comprising the steps to optionally prepare a patient's dental anatomy for a dental restoration 1010; obtain a digital three-dimensional model of a patient's dental anatomy comprising a tooth in need of restoration 1020; and compute a digital three-dimensional model of a dental restoration to fit within the patient's dental anatomy, the dental restoration comprising a first portion and a second portion integral to the first portion, wherein the second portion comprises a coupling configured to engage a tool, wherein the computing comprises determining a shape of the dental restoration 1030. The method may further comprise the additional steps to optionally generate, with an additive manufacturing device by an additive manufacturing process, the dental restoration based on the digital three-dimensional model of the dental restoration 1040; optionally attach a tool to the coupling of the second portion 1050; optionally place the first portion of the dental restoration in contact with the patient's dental anatomy or an indirect bonding tray 1060; and optionally separate the second portion from the first portion at a frangible section located at a connection point to the first portion 1070.

Suitable components of a photopolymerizable slurry or sol (e.g., ceramic particles, solvent, radiation curable monomer, photoinitiator, and inhibitor) are each discussed in detail below:

### Ceramic Particles

Photopolymerizable compositions comprising a sol or slurry of the present disclosure typically include particles of at least one ceramic material. In many embodiments, the ceramic particles comprise metal oxide ceramic particles, non-oxide ceramic particles, or any combination thereof.

Preferably, suitable ceramic particles are selected from the group consisting of zirconia (ZrO₂), silica (SiO₂), alumina (Al₂O₃), yttria (Y₂O₃), ceria (CeO₂), magnesium-magnesia aluminate (MMA), magnesium oxide (MgO), hydroxyapatite (Ca₅(PO₄)₃OH), fluorapatite (Ca₅(PO₄)₃F), chlorapatite (Ca₅(PO₄)₃Cl), calcite (CaCO₃), cordierite (Mg₂Al₄Si₅O₁₈), silicon carbide (SiC), silicon nitride (Si₃N₄), boron carbide (B₄C), titanium diboride (TiB₂), zirconium diboride (ZrB₂), boron nitride (BN), titanium carbide (TiC), zirconium carbide (ZrC), aluminium nitride (AlN), calcium hexaboride (CaB₆), MAX phase (Mₙ₊₁AXₙ), and any combination thereof. In select embodiments, high-purity particles are used, in which the total content of metal impurities is preferably less than 100 ppm, particularly preferably less than 50 ppm. In alternate embodiments, particles are used having a total content of metal impurities of about 2,000 ppm.

In certain embodiments, the ceramic particles may include a nano-filler. Optionally, the nano-filler comprises nano-cluster(s). One or more different kinds of nano-cluster(s) can be present. It has been found that compared to other fillers, using nano-cluster(s) can be beneficial because it allows for the formulation of a composition with high filler load resulting in better mechanical properties, e.g. polishability or abrasion and in higher aesthetics. The nano-cluster, if present, can typically be characterized by at least one or all of the following features:
Specific surface area: from 30 to 400 or from 60 to 300 or from 80 to 250 m²/g,
comprising particles of SiO₂, ZrO₂, Al₂O₃ and mixtures thereof.

If desired, the specific surface area of the nano-cluster can be determined according to the method of Brunauer, Emmet and Teller (BET), using a measurement device (e.g., MONOSORB, available from Quantachrome Instruments (Boynton Beach, Fla.)).

Suitable zirconia particles include for instance and without limitation, nano-sized zirconia particles(s) having at least one and up to all of the following parameters or features:
Primary particle size XRD (diameter): from 2 to 100 nm, 2 to 50 nm, 2 to 20 nm, 2 to 15 nm, or 4 to 15 nm;
being essentially spherical, cuboid or a mixture of spherical and cuboid;
being non-associated;
being crystalline;
not being coated with an inorganic coloring agent.
   Suitable nano-sized zirconia particles can have at least one and up to all of the following features:
ZrO₂ content: from 70 to 100 mol % or 80 to 97 mol %;
HfO₂ content: from 0 to 4.5 mol %, 0 to 3 mol %, or 0.1 to 2.8 mol %;
Stabilizer selected from Y₂O₃, CeO₂, MgO, CaO, La₂O₃ or a combination thereof in an amount from 0 to 30 mol %, 1.5 to 16 mol %, 2 to 10 mol %, or 2 to 5 mol %;
Al₂O₃ content: from 0 to 1 mol % or from 0.005 to 0.5 mol % or from 0.01 to 0.2 mol %.

According to one embodiment, the nano-sized zirconia particles are characterized as follows: ZrO₂ content: from 70 to 98.4 mol %; HfO₂ content: from 0.1 to 2.8 mol %; Y₂O₃ content: from 1.5 to 28 mol %.

Nano-sized zirconia particles can be obtained or are obtainable by a process comprising the steps of hydrothermal treatment of an aqueous metal salt solution or suspension (e.g. zirconium salt, yttrium salt). Such a process is described in WO 2013/055432 (Kolb et al).

Suitable silica particles include for instance and without limitation spherical silica particles and non-spherical silica particles. Spherical silica particles in aqueous media (sols) are well known in the art and are available commercially; for example, as silica sols in water or aqueous alcohol solutions under the trade designations LUDOX from W.R. Grace & Co. (Columbia, Md.), NYACOL from Nyacol Nanotechnologies Inc. (Ashland, Mass.), or NALCO from Nalco Company (Naperville, Ill.). One useful silica sol with a volume average particle size of 5 nm, a pH of 10.5, and a nominal solids content of 15 percent by weight, is available as NALCO 2326 from Nalco Company. Other useful commercially available silica sols include those available as NALCO 1115 and NALCO 1130 from Nalco Company, as REMASOL SP30 from Remet Corp. (Utica, N.Y.), and as LUDOX SM from W.R. Grace & Co. Other suitable silica particles include fumed silica. Agglomerated silica particles are commercially available, e.g., from Degussa, Cabot Corp or Wacker under the product designation AEROSIL, CAB-O-SIL and HDK. The specific surface of the hydrophobic fumed silica is typically from 100 to 300 m²/g or from 150 to 250 m²/g. A mixture of different fumed silica can be used, if desired. For example, a mixture of fumed silica the surface of which has been treated with a hydrophobic surface treating agent and fumed silica the surface of which has been treated with a hydrophilic surface treating agent can be used. A suitable nano-silica comprising aggregated nano-sized particles can be produced according to the processes described, e.g., in U.S. Pat. No. 6,730,156 (Zhang et al; preparatory example A).

Suitable alumina particles include for instance and without limitation aqueous alumina dispersions (e.g., average particle size of 500 nm alumina particles available from Sumitomo Chemicals (New York, N.Y.)) and alumina particles from Saint-Gobain Surface Conditioning Group (Anaheim, Calif.).

Suitable yttria particles include for instance and without limitation yttrium oxide available from Treibacher Industrie AG (Althofen, Austria).

Suitable ceria particles include for instance and without limitation colloidal cerium oxide in the form of colloidal sols and nano-structured powders available from NYACOL Nano Technologies, Inc (Ashland, Mass.). NYACO CDP, for example, has a particle size of 25-30 nm and is a dispersible ceria powder, while NYACOL Ce120/10 is colloidal ceria having a particle size of 100-140 nm and water as a carrier.

Suitable magnesium-magnesia aluminate particles include for instance and without limitation magnesium aluminate spinel in the form of nano-structured powders available from American Elements (Los Angeles, Calif.). 99.9% Magnesium Aluminate, Spinel Nanopowder, for example, has a nominal particle size of less than 50 nm. Larger particle powders are available from Reade International, Corp (Riverside, R.I.) as Spinel Powder (MgAl₂O₄), with a particle size of 1-5 micrometers.

Suitable magnesium oxide particles include for instance and without limitation particles in the form of a water dispersion. It should be understood, however, that a certain amount of magnesium oxide converts to magnesium hydroxide in the presence of water. Preferred magnesium oxide dispersions are made from commercially available magnesium oxide such as ELASTOMAG 170 from Martin Marietta Magnesia Specialties, LLC (Baltimore, Md.) and MAGLITE A from Hallstar (Chicago, Ill.). Magnesium oxides may be dispersed by those skilled in the art or obtained from vendors such as Tiarco Chemical and H. M. Royal.

Suitable apatite particles include for instance and without limitation, hydroxyapatite, fluorapatite and chlorapatite, with high concentrations of OFF, and CF ions, respectively, in the crystal. For example, suitable hydroxyapatite particles include for instance and without limitation hydroxyapatite from CAM Bioceramics (Leiden, The Netherlands). Hydroxyapatite has been used as a bone substitute because natural bone is approximately 70% hydroxyapatite by weight and 50% hydroxyapatite by volume. Hydroxyapatite has also been widely used for various implant applications such as bioactive space fillers, as scaffolding for the in-growth of tissues, and as a coating for implants to promote bonding with tissue. Syntheses of chlorapatite and fluorapatite have been reported in the literature, such as in Sanjeevi et al., Journal of the European Ceramic Society, 2007, 27, 2287-2294; Montazeri et al., International Journal of Nanomedicine, 2011, 6, 197-201; and Ghomi et al., Materials Research Innovations, 2013, 17:4, 257-262.

Suitable calcite particles include for instance and without limitation calcite nanoparticles commercially available under the trade designations “MULTIFEX MM” and “ALBAFIL” from the Cary Company (Addison, Ill.); “SOCAL 31” from Solvay Specialty Chemicals, LTD. (Houston, Tex.); and “NPCC-111” and “NPCC-113” from NanoMaterials Technology LTD (Singapore).

Suitable cordierite particles include for instance and without limitation cordierite particles commercially available from Reade International, Corp (Riverside, R.I.) as Cordierite powder with an average particle size of 6-7 micrometers, and from American Elements (Los Angeles, Calif.) as Cordierite or Magnesium Aluminum Silicate.

Suitable silicon nitride particles include for instance and without limitation powders having a mean particle or agglomerate size (D₅₀) of 0.5-20 micrometers, such as 1-10 micrometers. The oxygen content of silicon nitride powder is preferably less than 2% by weight and the total carbon content is preferably less than 0.35% by weight. A commercially available silicon nitride powder can be obtained under the trade designation SILZOT from AlzChem Group AG (Trastber, Germany).

Suitable boron carbide particles include for instance and without limitation, B₄C powders having a purity of 97% by weight or higher, and a mean particle size (D₅₀) of 0.1-8 micrometers. An example of a suitable boron carbide powder is 3M Boron Carbide Powder commercially available from 3M Company (St. Paul, Minn.).

Suitable titanium diboride particles include for instance and without limitation, TiB₂ powders having a mean particle size (D₅₀) of about 2-20 micrometers. An example of a suitable titanium diboride powder is 3M Titanium Diboride Powder commercially available from 3M Company.

Suitable zirconium diboride particles include for instance and without limitation, high purity or ultra-high purity ZrB₂ powders available from American Elements (Los Angeles, Calif.).

Suitable boron nitride particles include for instance and without limitation, agglomerates of platelet-shaped, hexagonal boron nitride primary particles, wherein the hexagonal boron nitride primary particles are connected to one another by means of an inorganic binding phase. The inorganic binding phase comprises at least one nitride and/or oxynitride. The nitrides or oxynitrides are preferably compounds of the elements aluminum, silicon, titanium and boron. An example of a suitable boron nitride powder is 3M Boron Nitride Cooling Fillers Platelets commercially available from 3M Company.

Suitable titanium carbide particles include for instance and without limitation, TiC powders having a mean particle size (D₅₀) of 1 to 3 micrometers. An example of a suitable titanium carbide powder is TiC Grade High Vacuum 120 commercially available from HC-Starck (Munich, Germany).

Suitable zirconium carbide particles include for instance and without limitation, ZrC powders having a mean particle size (D₅₀) of 3 to 5 micrometers. An example of a suitable zirconium carbide powder is ZrC Grade B commercially available from HC-Starck.

Suitable aluminum nitride particles include for instance and without limitation, AlN powders having a mean particle size (D₅₀) of 0.8 to 2 micrometers. An example of a suitable aluminum nitride powder is AlN Grade C commercially available from HC-Starck.

Suitable calcium hexaboride particles include for instance and without limitation, CaB₆ powders commercially available from 3M Company as 3M Calcium Hexaboride.

MAX phase particles are layered hexagonal carbides and nitrides having the general formula of Mₙ₊₁AX₁₁, wherein n=1 to 3, M is an early transition metal, A is an A-group element, and X is independently selected from carbon and nitrogen. The A-group elements are preferably elements 13-16. An example of a suitable MAX phase powder is MAXTHAL 312 powder commercially available from Kanthal (Hallstahammar, Sweden).

In some embodiments, the photopolymerizable slurry or sol comprises 20 wt. % or greater ceramic particles, based on the total weight of the photopolymerizable slurry or sol, 21 wt. % or greater, 22 wt. %, 23 wt. %, 24 wt. %, 25 wt. %, 26 wt. %, 27 wt. %, 28 wt. %, 29 wt. %, 30 wt. %, 32 wt. % or 35 wt. % or greater; and 60 wt. % or less, 29.5 wt. % or less, 28.5 wt. % or less, 27.5 wt. % or less, 26.5 wt. % or less, 25.5 wt. % or less, or 24.5 wt. % or less ceramic particles, based on the total weight of the photopolymerizable slurry or sol. Stated another way, the photopolymerizable slurry or sol can include between 20 percent by weight and 60 percent by weight of ceramic particles, based on the total weight of the photopolymerizable slurry or sol.

In some embodiments, the photopolymerizable slurry or sol comprises 3 volume percent (vol. %) or greater ceramic particles, based on the total volume of the photopolymerizable slurry or sol, 4 vol. %, 5 vol. %, 6 vol. %, 7 vol. %, 8 vol. %, 9 vol. %, 10 vol. %, 11 vol. %, 12 vol. %, 13 vol. %, 14 vol. %, 15 vol. %, 17 vol. %, 19 vol. %, 21 vol. %, 23 vol. %, 25 vol. % or 29 vol. % or greater; and 45 vol. % or less, 44 vol. %, 42 vol. %, 40 vol. %, 38 vol. %, 36 vol. %, 34 vol. %, 32 vol. %, or 30 vol. % or less ceramic particles, based on the total volume of the photopolymerizable slurry or sol. Stated another way, the photopolymerizable slurry or sol can include for instance, between 3 percent by volume and 45 percent by volume of ceramic particles, 5 vol. % to 45 vol. %, or 10 vol. % to 45 vol. % ceramic particles, based on the total volume of the photopolymerizable slurry or sol.

The ceramic particles typically comprise an average (mean) particle size diameter (i.e., D₅₀) of 1 nanometer (nm) or greater, 3 nm, 4 nm, 5 nm, 6 nm, 7 nm, 8 nm, 9 nm, 10 nm, 12 nm, 15 nm, 17 nm, 20 nm, 25 nm, 30 nm, 40 nm, 50 nm, 60 nm, 75 nm, 90 nm, 100 nm, 125 nm, 150 nm, 175 nm, 200 nm, 225 nm, 250 nm, 350 nm, 500 nm, 750 nm, 1 micrometer, 1.25 micrometers, 1.5 micrometers, 1.75 micrometers, 2 micrometers, 2.5 micrometers, 3.0 micrometers, 3.5 micrometers, 4.0 micrometers, or 4.5 micrometers or greater; and a D₅₀ of 10 micrometers or less, 9.5 micrometers, 9 micrometers, 8.5 micrometers, 8 micrometers, 7.5 micrometers, 7 micrometers, 6.5 micrometers, 6 micrometers, 5.5 micrometers, 5 micrometers, 4.5 micrometers, 3 micrometers, 2 micrometers, 1.5 micrometers, 1 micrometer, 900 nm, 800 nm, 700 nm, 600 nm, 500 nm, 400 nm, 300 nm, or 250 nm or less. Stated another way, the ceramic particles may have an average particle size diameter (D₅₀) of 1 nm to 900 nm, 1 nm to 500 nm, 1 nm to 250 nm, 250 nm to 10 micrometers, 1 micrometer to 10 micrometers, 500 nanometers to 1.5 micrometers, or of 250 nm to 1 micrometer. The average (mean) particle size (D₅₀) refers to that particle diameter at which 50 percent by volume of the particles in a distribution of particles have that diameter or a smaller diameter, as measured by laser diffraction. Preferably, the average particle size is of the primary particles.

### Sintering Aid

The photopolymerizable compositions of the present disclosure optionally include at least one sintering aid. Often, sintering aids assist by removing oxygen during the sintering process. Also, a sintering aid may provide a phase that melts from a solid to a liquid at a lower temperature than the ceramic material, or may provide some alternate mechanism that improves transport of ceramic ions and thus increases densification as compared to a composition not containing the sintering aid.

Suitable sintering aids are not particularly limited, and may include rare earth oxides, alkaline earth oxides, alkali oxides, and combinations thereof. Materials that yield liquids at the sintering temperature of the ceramic particles can be useful.

Rare earth oxides include cerium oxide (e.g., CeO₂), dysprosium oxide (e.g., Dy₂O₃), erbium oxide (e.g., Er₂O₃), europium oxide (e.g., Eu₂O₃), gadolinium oxide (e.g., Gd₂O₃), holmium oxide (e.g., Ho₂O₃), lanthanum oxide (e.g., La₂O₃), lanthanum aluminum oxide (LaAlO₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium oxide (e.g., Tb₂O₃), thorium oxide (e.g., Th₄O₇), thulium oxide (e.g., Tm₂O₃), ytterbium oxide (e.g., Yb₂O₃), and yttrium oxide (e.g., Y₂O₃), and combinations thereof.

Alkaline earth oxides include barium oxide (BaO), calcium oxide (CaO), strontium oxide (SrO), magnesium oxide (MgO), and beryllium oxide (BeO), and combinations thereof.

Alkali oxides include lithium oxide (Li₂O₂), sodium oxide (Na₂O₂), potassium oxide (K₂O), rubidium oxide (Rb₂O), and cesium oxide (Cs₂O), and combinations thereof.

In some embodiments, a mixture of an alkaline earth oxide and a rare earth oxide is preferable, such as a combination of aluminum oxide and yttrium oxide.

Additional suitable sintering aids include for instance and without limitation, boron, carbon, magnesium, aluminum, silicon, titanium, vanadium, chromium, iron, nickel, copper, aluminum nitride, alumina, yttria, ethyl silicate, sodium silicate with Mg(NO₃)₂, other glasses, Fe₂O₃, MgF₂, and combinations thereof.

In some embodiments, suitable sintering aids comprise aluminum oxide, yttrium oxide, zirconium oxide, silicon oxide, titanium oxide, magnesium oxide, calcium oxide, strontium oxide, barium oxide, lithium oxide, sodium oxide, potassium oxide, carbon, boron, boron carbide, aluminum, aluminum nitride, or combinations thereof. For instance, suitable commercially available sintering aids include Calcined Alumina from Almatis (Ludwigshafen, Germany) and Yttrium Oxide from Treibacher Industrie AG (Althofen, Austria).

### Coloring Agents

Photopolymerizable compositions according to embodiments of the present disclosure may further comprise one or more inorganic coloring agent(s). The nature and structure of the inorganic coloring agent(s) is not particularly limited, unless the desired result cannot be achieved. In preferred embodiments, the metal ion is not a free salt, but rather is incorporated into the ceramic particles. Up to 30 mole %, up to 25 mole %, up to 20 mole %, up to 10 mole %, up to 5 mole %, up to 2 mole %, or up to 1 mole % of the ceramic particles can be Y₂O₃, La₂O₃, Al₂O₃, CeO₂, Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, Fe₂O₃, MnO₂, Co₂O₃, Cr₂O₃, NiO, CuO, V₂O₃, Bi₂O₃, Ga₂O₃, Lu₂O₃, HfO₂, or mixtures thereof. Inorganic oxides such as Fe₂O₃, MnO₂, Co₂O₃, Cr₂O₃, NiO, CuO, Ga₂O₃, Er₂O₃, Pr₂O₃, Eu₂O₃, Dy₂O₃, Sm₂O₃, V₂O₃, or W₂O₃ may be added, for example, to alter the color of the ceramic article to be produced.

If the slurry or sol is to be used for producing dental or orthodontic articles, the following inorganic coloring agent(s) were found to be useful: salts of Mn, Fe, Cu, Pr, Nd, Sm, Eu, Tb, Dy, Er, Bi and mixtures thereof, preferably Er, Tb, Mn, Bi, Nd or Fe, Pr, Co, Cr or V, Cu, Eu, Sm, Dy, with Er, Tb, Mn, Bi, Nd being sometimes particularly preferred. Including a coloring agent may be particularly desirable when the ceramic particles comprise zirconia.

If present, the inorganic coloring agent(s) is present in an amount, based on the moles of the coloring ion being present in the coloring agent and with respect to the total moles of inorganic oxide in the ceramic particles, of 0.001 mole % or greater, 0.005 mole %, or 0.01 mole % or greater; and 0.02 mole % or less, 0.05 mole %, or 0.5 mole % or less.

### Solvent

In many embodiments, the photopolymerizable slurry or sol according to the present disclosure further comprises at least one (e.g., organic or aqueous) solvent. Suitable solvents are typically selected to be miscible with water. Further, these solvents are often selected to be soluble in supercritical carbon dioxide or liquid carbon dioxide. The molecular weight of the solvent is usually at least 25 grams/mole (g/mol), 30 g/mol, 40 g/mol, 45 g/mol, 50 g/mol, 75 g/mol, or at least 100 g/mol. The molecular weight can be up to 300 g/mol, 250 g/mol, 225 g/mol, 200 g/mol, 175 g/mol, or up to 150 g/mol. The molecular weight is often in a range of 25 to 300 g/mol, 40 to 300 g/mol, 50 to 200 g/mol, or 75 to 175 g/mol. It is particularly preferable that the one or more solvents have a boiling point above a temperature employed during the additive manufacturing process to minimize solvent evaporation from the sol, slurry, or gelled article. For instance, at least one solvent may be used having a boiling point of 150° C. or greater, 160° C., 170° C., 180° C., or 190° C. or greater.

In certain embodiments, the amount of one or more solvents in a photopolymerizable slurry or sol is 10 wt. % or more, 15 wt. %, 20 wt. %, 25 wt. %, 30 wt. %, 35 wt. %, 40 wt. %, or 45 wt. % or more, based on the total weight of the photopolymerizable slurry or sol; and 70 wt. % or less, 65 wt. %, 60 wt. %, 55 wt. %, or 50 wt. % or less, based on the total weight of the photopolymerizable slurry or sol. Stated another way, the photopolymerizable slurry or sol may contain 10 to 70 wt. % solvent, or 20 to 50 wt. % solvent, based on the total weight of the photopolymerizable slurry or sol. Advantageously, in certain embodiments, the presence of solvent can assist in maintaining a pore structure in an article for removing organic material from the article.

Suitable solvents include for instance and without limitation, diethylene glycol monoethyl ether, ethanol, 1-methoxy-2-propanol (i.e., methoxy propanol), isopropanol, ethylene glycol, N,N-dimethylacetamide, N-methyl pyrrolidone, water, and combinations thereof. A suitable solvent is often a glycol or polyglycol, mono-ether glycol or mono-ether polyglycol, di-ether glycol or di-ether polyglycol, ether ester glycol or ether ester polyglycol, carbonate, amide, or sulfoxide (e.g., dimethyl sulfoxide). The solvent usually has one or more polar groups. The solvent does not have a polymerizable group; that is, the (e.g., organic) solvent is free of a group that can undergo free radical polymerization. Further, no component of the solvent medium has a polymerizable group that can undergo free radical polymerization.

In some embodiments, the solvent contains less than 15 weight percent water, less than 10 percent water, less than 5 percent water, less than 3 percent water, less than 2 percent water, less than 1 weight percent, or even less than 0.5 weight percent water.

Suitable glycols or polyglycols, mono-ether glycols or mono-ether polyglycols, di-ether glycols or di-ether polyglycols, and ether ester glycols or ether ester polyglycols are often of Formula (I).

R¹O—(R²O)ₙ—R¹ (I)

In Formula (I), each R¹ independently is hydrogen, alkyl, aryl, or acyl. Suitable alkyl groups often have 1 to 10 carbon atoms, 1 to 6 carbon atoms, or 1 to 4 carbon atoms. Suitable aryl groups often have 6 to 10 carbon atoms and are often phenyl or phenyl substituted with an alkyl group having 1 to 4 carbon atoms. Suitable acyl groups are often of formula —(CO)R³ where R³ is an alkyl having 1 to 10 carbon atoms, 1 to 6 carbon atoms, 1 to 4 carbon atoms, 2 carbon atoms, or 1 carbon atom. The acyl is often an acetate group (—(CO)CH₃). In Formula (I), each R² is typically ethylene or propylene. The variable n is at least 1 and can be in a range of 1 to 10, 1 to 6, 1 to 4, or 1 to 3.

Glycols or polyglycols of Formula (I) have two R¹ groups equal to hydrogen. Examples of glycols include, but are not limited to, ethylene glycol, propylene glycol, diethylene glycol, dipropylene glycol, triethylene glycol, and tripropylene glycol.

Mono-ether glycols or mono-ether polyglycols of Formula (I) have a first R¹ group equal to hydrogen and a second R¹ group equal to alkyl or aryl. Examples of mono-ether glycols or mono-ether polyglycols include, but are not limited to, ethylene glycol monohexyl ether, ethylene glycol monophenyl ether, propylene glycol monobutyl ether, diethylene glycol monomethyl ether, diethylene glycol monoethyl ether, diethylene glycol monopropyl ether, diethylene glycol monobutyl ether, diethylene glycol monohexyl ether, dipropylene glycol monomethyl ether, dipropylene glycol monoethyl ether, dipropylene glycol monopropyl ether, triethylene glycol monomethyl ether, triethylene glycol monoethyl ether, triethylene glycol monobutyl ether, tripropylene glycol monomethyl ether, and tripropylene glycol monobutyl ether.

Di-ether glycols or di-ether polyglycols of Formula (I) have two R¹ groups equal to alkyl or aryl. Examples of di-ether glycols or di-ether polyglycols include, but are not limited to, ethylene glycol dipropyl ether, ethylene glycol dibutyl ether, dipropylene glycol dibutyl ether, diethylene glycol dimethyl ether, diethylene glycol diethyl ether, triethylene glycol dimethyl ether, tetraethylene glycol dimethyl ether, and pentaethylene glycol dimethyl ether.

Ether ester glycols or ether ester polyglycols of Formula (I) have a first R¹ group equal to an alkyl or aryl and a second R¹ group equal to an acyl. Examples of ether ester glycols or ether ester polyglycols include, but are not limited to, ethylene glycol butyl ether acetate, diethylene glycol butyl ether acetate, and diethylene glycol ethyl ether acetate.

Other suitable solvents are carbonates of Formula (II).

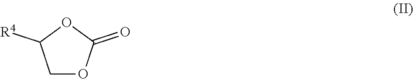

In Formula (II), R⁴ is hydrogen or an alkyl such as an alkyl having 1 to 4 carbon atoms, 1 to 3 carbon atoms, or 1 carbon atom. Examples include ethylene carbonate and propylene carbonate.

Yet other suitable solvents are amides of Formula (III).

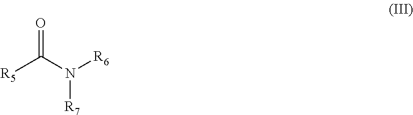

In Formula (III), group R⁵ is hydrogen, alkyl, or combines with R⁶ to form a five-membered ring including the carbonyl attached to R⁵ and the nitrogen atom attached to R⁶. Group R⁶ is hydrogen, alkyl, or combines with R⁵ to form a five-membered ring including the carbonyl attached to R⁵ and the nitrogen atom attached to R⁶. Group R⁷ is hydrogen or alkyl. Suitable alkyl groups for R⁵, R⁶, and R⁷ have 1 to 6 carbon atoms, 1 to 4 carbon atoms, 1 to 3 carbon atoms, or 1 carbon atom. Examples of amide organic solvents of Formula (III) include, but are not limited to, formamide, N,N-dimethylformamide, N,N-dimethylacetamide, N,N-diethylacetamide, N-methyl-2-pyrrolidone, and N-ethyl-2-pyrrolidone.

Additionally, in certain embodiments, the photopolymerizable slurry or sol further comprises a dispersant to assist in distributing the ceramic particles in the photopolymerizable slurry or sol. Typically, one or more dispersants can be present in a photopolymerizable slurry or sol in an amount of 0.5 wt. % or greater, based on the total weight of the photopolymerizable slurry or sol, 0.55 wt. % or greater, 0.60 wt. %, 0.65 wt. %, or 0.70 wt. % or greater; and 5.0 wt. % or less, 4.0 wt. %, 3.0 wt. %, 2.0 wt. %, 1.0 wt. %, 0.95 wt. %, 0.90 wt. %, 0.85 wt. %, 0.80 wt. %, or 0.75 wt. % or less, based on the total weight of the photopolymerizable slurry or sol. Stated another way, the optional dispersant may be present in an amount of 0.5 wt. % to 5.0 wt. %, based on the total weight of the photopolymerizable slurry or sol. Suitable dispersants include for instance and without limitation, dispersants available under the trade designations SOLPLUS or SOLSPERSE from Lubrizol (Wickliffe, Ohio), such as SOLPLUS D510, R700, R720, D540, D545, and D570, SOLSPERSE 20000, S71000, M387, M389, S41000, and S79000, and combinations thereof.

### Radiation Curable Monomer

The photopolymerizable slurry or sol described in the present text comprises one or more radiation curable monomers being part of or forming an organic matrix.

The radiation curable monomer(s) being present in the photopolymerizable slurry or sol can be described as first, second, third, etc., monomer. The nature and structure of the radiation curable monomer(s) is not particularly limited unless the desired result cannot be achieved. In some embodiments, the at least one radiation curable monomer comprises an acrylate. Preferably, the at least one radiation curable monomer includes a (meth)acrylate, an epoxy, a silane, or combinations thereof.

In some embodiments, upon polymerization, the radiation curable monomers form a network with the (preferably) homogeneously dispersed ceramic particles.

According to one embodiment, the photopolymerizable slurry or sol contains as a first monomer a polymerizable surface modification agent. Optionally, at least a portion of the ceramic particles in the photopolymerizable slurry or sol may comprise a surface modifier attached to a surface of the ceramic particles. A surface modifier may help to improve compatibility of the particles contained in the slurry or sol with an organic matrix material also present in the slurry or sol. Surface modifiers may be represented by the formula A-B, where the A group is capable of attaching to the surface of a ceramic particle and the B group is radiation curable.

Group A can be attached to the surface of the ceramic particle by adsorption, formation of an ionic bond, formation of a covalent bond, or a combination thereof. Examples of suitable Group A moieties include acidic moieties (like carboxylic acid groups, phosphoric acid groups, sulfonic acid groups and anions thereof) and silanes. Group B comprises a radiation curable moiety. Examples of suitable Group B moieties include vinyl, in particular acryl or methacryl moieties.

Suitable surface modifiers comprise polymerizable carboxylic acids and/or anions thereof, polymerizable sulfonic acids and/or anions thereof, polymerizable phosphoric acids and/or anions thereof, and polymerizable silanes. Suitable surface modification agents are further described, for example, in WO 2009/085926 (Kolb et al.), the disclosure of which is incorporated herein by reference.

An example of a radically polymerizable surface modifier is a polymerizable surface modification agent comprising an acidic moiety or anion thereof, e.g. a carboxylic acid group. Exemplary acidic radically polymerizable surface modifiers include acrylic acid, methacrylic acid, beta-carboxyethyl acrylate, and mono-2-(methacryloxyethyl)succinate.

Exemplary radically polymerizable surface modifiers can be reaction products of hydroxyl-containing polymerizable monomers with cyclic anhydrides such as succinic anhydride, maleic anhydride and phthalic anhydride. Exemplary polymerizable hydroxyl-containing monomers include hydroxyethyl acrylate, hydroxyethyl methacrylate, hydroxypropyl acrylate, hydroxypropyl methacrylate, hydroxybutyl acrylate, and hydroxybutyl methacrylate. Acryloxy and methacryloxy functional polyethylene oxide and polypropylene oxide may also be used as the polymerizable hydroxyl-containing monomers.

An exemplary radically polymerizable surface modifier for imparting both polar character and reactivity to the ceramic nanoparticles is mono(methacryloxypolyethyleneglycol) succinate.

Another example of a radically polymerizable surface modifier is a polymerizable silane. Exemplary polymerizable silanes include methacryloxyalkyltrialkoxysilanes or acryloxy-alkyltrialkoxysilanes (e.g., 3-methacryloxypropyltrimethoxysilane, 3-acryloxypropyltrimethoxysilane, and 3-(methacryloxy)propyltriethoxysilane); methacryloxyalkylalkyldialkoxysilanes or acryloxyalkylalkyldialkoxysilanes (e.g., 3-(methacryloxy)propylmethyldimethoxysilane and 3-(acryloxypropyl)methyldimethoxysilane); methacryloxyalkyldialkylalkoxysilanes or acyrloxyalkyldialkylalkoxysilanes (e.g., 3-(methacryloxy)propyldimethylethoxysilane); mercapto-alkyltrialkoxylsilanes (e.g., 3-mercaptopropyltrimethoxysilane); aryltrialkoxysilanes (e.g., styrylethyltrimethoxysilane); vinylsilanes (e.g., vinylmethyldiacetoxysilane, vinyldimethylethoxysilane, vinylmethyldiethoxysilane, vinyltrimethoxysilane, vinyltriethoxysilane, vinyltriacetoxysilane, vinyltriisopropoxysilane, and vinyltris(2-methoxyethoxy)silane).

A surface modifier can be added to the ceramic particles using conventional techniques. The organic matrix can be added before or after surface modification or simultaneously with surface modification. Various methods of adding the surface modification agent are further described, for example, in WO 2009/085926 (Kolb et al.), the disclosure of which is incorporated herein by reference.

The surface modification reactions can occur at room temperature (e.g., 20° C. to 25° C.) or at an elevated temperature (e.g., up to 95° C.). When the surface modifiers are acids such as carboxylic acids, the ceramic particles typically can be surface-modified at room temperature. When the surface modification agents are silanes, the ceramic particles are typically surface modified at elevated temperatures.

The optional first monomer can function as a polymerizable surface modification agent. Multiple first monomers can be used. The first monomer can be the only kind of surface modifier or can be combined with one or more other non-polymerizable surface modifiers. In some embodiments, the amount of the first monomer is at least 20 wt. % based on a total weight of polymerizable material (radiation curable monomers). For example, if present, the amount of the first monomer is often at least 25 wt. %, at least 30 wt. %, at least 35 wt. %, or at least 40 wt. %. The amount of the first monomer can be up to 100 wt. %, up to 90 wt. %, up to 80 wt. %, up to 70 wt. %, up to 60 wt. %, or up to 50 wt. %. Some photopolymerizable slurries or sols contain 20 to 100 wt. %, 20 to 80 wt. %, 20 to 60 wt. %, 20 to 50 wt. %, or 30 to 50 wt. % of the first monomer based on a total weight of polymerizable material.

The optional first monomer (i.e., the polymerizable surface modification agent) can be the only monomer in the polymerizable material or it can be combined with one or more second monomers, as described in further detail below.

According to one embodiment, the photopolymerizable slurry or sol comprises one or more second monomers comprising at least one or two radiation curable moieties. In particular, the second monomers comprising at least two radiation curable moieties may act as crosslinker(s) during the gel-forming step. Any suitable second monomer that does not have a surface modification group can be used. The second monomer does not have a group being capable of attaching to the surface of a ceramic particle. That is, the optional second monomer does not have a carboxylic acid group or a silyl group. The second monomers are often polar monomers (e.g., non-acidic polar monomers), monomers having a plurality of polymerizable groups, alkyl (meth)acrylates and mixtures thereof.

A successful build typically requires a certain level of gel strength as well as shape resolution, and adding a second monomer comprising at least two radiation curable moieties to the photopolymerizable slurry or sol described herein may facilitate the optimization both properties. A crosslinked approach often allows for greater gel strength to be realized at a lower energy dose since the polymerization creates a stronger network. In some examples, higher energy doses have been applied to increase layer adhesion of non-crosslinked systems. While an article is successfully built, the higher energy often impacts the resolution of the final article, causing overbuild to potentially occur, especially in the case of highly translucent materials where the light, and with it the cure depth, can penetrate further into the material. The presence of a monomer having a plurality of polymerizable groups tends to enhance the strength of the gel composition formed when the photopolymerizable slurry or sol is polymerized. The amount of the monomer with a plurality of polymerizable groups can be used to adjust the flexibility and the strength of the gelled body, and indirectly optimize the gelled body resolution and final article resolution. Such gel compositions can be easier to process without cracking, and in the case of transforming the gel into a fully dense ceramic, increased gel strength aids in the robustness of the post-building procedures.

In many embodiments, the second monomer includes a monomer having a plurality of polymerizable groups. The number of polymerizable groups can be in a range of 2 to 6 or even higher. In many embodiments, the number of polymerizable groups is in a range of 2 to 5 or 2 to 4. The polymerizable groups are typically (meth)acryloyl groups.

Exemplary monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Exemplary monomers with three or four (meth)acryloyl groups include, but are not limited to, trimethylolpropane triacrylate (e.g., commercially available under the trade designation TMPTA-N from Cytec Industries, Inc. (Smyrna, Ga., USA) and under the trade designation SR-351 from Sartomer (Exton, Pa., USA)), pentaerythritol triacrylate (e.g., commercially available under the trade designation SR-444 from Sartomer), ethoxylated (3) trimethylolpropane triacrylate (e.g., commercially available under the trade designation SR-454 from Sartomer), ethoxylated (4) pentaerythritol tetraacrylate (e.g., commercially available under the trade designation SR-494 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), and di-trimethylolpropane tetraacrylate (e.g., commercially available under the trade designation SR-355 from Sartomer).

Exemplary monomers with five or six (meth)acryloyl groups include, but are not limited to, dipentaerythritol pentaacrylate (e.g., commercially available under the trade designation SR-399 from Sartomer) and a hexa-functional urethane acrylate (e.g., commercially available under the trade designation CN975 from Sartomer).

In some embodiments, the radiation curable monomer comprises an epoxy. Epoxy compounds which are suitable for use as photopolymerizable slurries or sols include, for instance and without limitation, cycloaliphatic oxiranes, aliphatic oxiranes, aromatic oxiranes, or a combination thereof. These compounds, which are widely known as epoxy compounds, can be monomeric, polymeric, or mixtures thereof. These materials generally have, on the average, at least one polymerizable epoxy group (oxirane unit) per molecule, and preferably at least about 1.5 polymerizable epoxy groups per molecule. The polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). The epoxides may be pure compounds or may be mixtures containing one, two, or more epoxy groups per molecule. The “average” number of epoxy groups per molecule is determined by dividing the total number of epoxy groups in epoxy-containing material by the total number of epoxy molecules present. The epoxy compounds may have a molecular weight of from about 58 to about 100,000 or more.

Suitable epoxy compounds include those which contain cyclohexene oxide groups, such as the epoxycyclohexanecarboxylates, for example, 3,4-epoxycyclohexylmethyl-3,4-epoxy cyclohexanecarboxylate, 3,4-epoxy-2-methylcyclohexylmethyl-3,4-epoxy-2-methylcyclohexane carboxylate, and bis(3,4-epoxy-6-methylcyclohexylmethyl) adipate. A more detailed list of useful epoxides of this nature is provided in U.S. Pat. No. 3,117,099 (Proops et al).

Suitable epoxy compounds also include glycidyl ether compounds, such as glycidoxyalkyl and glycidoxyaryl compounds containing 1 to 6 glycidoxy groups. Examples include glycidyl ethers of polyhydric phenols, which can be obtained by reacting the polyhydric phenol with an excess of epichlorohydrin to provide, for example, 2,2-bis(2,3-epoxypropoxyphenyl)propane. Additional epoxides of this type are described in U.S. Pat. No. 3,018,262 (Schroeder), and in “Handbook of Epoxy Resins” by Lee and Neville, McGraw-hill Book Co., New York (1967). Many suitable epoxy compounds are commercially available and are listed in U.S. Pat. No. 6,187,833 (Oxman et al).

Some photopolymerizable slurry or sol compositions contain 0 to 80 wt. % of a second monomer having a plurality of polymerizable groups based on a total weight of the polymerizable material. For example, the amount can be in a range of 10 to 80 wt. %, 20 to 80 wt. %, 30 to 80 wt. %, 40 to 80 wt. %, 10 to 70 wt. %, 10 to 50 wt. %, 10 to 40 wt. %, or 10 to 30 wt. %.

The overall composition of the polymerizable material is often selected so that the polymerized material is soluble in a solvent medium. Homogeneity of the organic phase is often preferable to avoid phase separation of the organic component in the gel composition. This tends to result in the formation of smaller and more homogeneous pores (pores with a narrower size distribution) in the subsequently formed aerogel or xerogel. Further, the overall composition of the polymerizable material can be selected to adjust compatibility with a solvent medium and to adjust the strength, flexibility, and uniformity of the gel composition. Still further, the overall composition of the polymerizable material can be selected to adjust the burnout characteristics of the organic material prior to sintering.

In some embodiments, the optional second monomer is a polar monomer. As used herein, the term “polar monomer” refers to a monomer having a free radical polymerizable group and a polar group. The polar group is typically non-acidic and often contains a hydroxyl group, a primary amido group, a secondary amido group, a tertiary amido group, an amino group, or an ether group (i.e., a group containing at least one alkylene-oxy-alkylene group of formula —R—O—R— where each R is an alkylene having 1 to 4 carbon atoms).

Suitable optional polar monomers having a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), and hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer under the trade designation CD570, CD571, and CD572), and aryloxy substituted hydroxyalkyl (meth)acrylates (e.g., 2-hydroxy-2-phenoxypropyl (meth)acrylate).

Exemplary polar monomers with a primary amido group include (meth)acrylamide. Exemplary polar monomers with secondary amido groups include, but are not limited to, N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide. Exemplary polar monomers with a tertiary amido group include, but are not limited to, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

Exemplary polar monomers with an ether group include, but are not limited to, alkoxylated alkyl (meth)acrylates such as ethoxyethoxyethyl (meth)acrylate, 2-methoxyethyl (meth)acrylate, and 2-ethoxyethyl (meth)acrylate; and poly(alkylene oxide) (meth)acrylates such as poly(ethylene oxide) (meth)acrylates, and poly(propylene oxide) (meth)acrylates. The poly(alkylene oxide) acrylates are often referred to as poly(alkylene glycol) (meth)acrylates. These monomers can have any suitable end group such as a hydroxyl group or an alkoxy group. For example, when the end group is a methoxy group, the monomer can be referred to as methoxy poly(ethylene glycol) (meth)acrylate.

Suitable alkyl (meth)acrylates that can be used as a second monomer can have an alkyl group with a linear, branched, or cyclic structure. Examples of suitable alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, 3,3,5-trimethylcyclohexyl (meth)acrylate, n-decyl (meth)acrylate, isodecyl (meth)acrylate, isobornyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate. In some embodiments, the alkyl (meth)acrylates are a mixture of various isomers having the same number of carbon atoms as described in PCT Patent Application Publication WO 2014/151179 (Colby et al). For example, an isomer mixture of octyl (meth)acrylate can be used.

The amount of a second monomer that is a polar monomer and/or an alkyl (meth)acrylate monomer is often in a range of 0 to 40 wt. %, 0 to 35 wt. %, 0 to 30 wt. %, 5 to 40 wt. %, or 10 to 40 wt. % based on a total weight of the polymerizable material.

The total amount of polymerizable material is often at least 10 wt. %, at least 12 wt. %, at least 15 wt. %, or at least 18 wt. % based on the total weight of the photopolymerizable sol or slurry. The amount of polymerizable material can be up to 50 wt. %, up to 40 wt. %, up to 30 wt. %, or up to 20 wt. %, based on the total weight of the photopolymerizable sol or slurry. For example, the amount of polymerizable material can be in a range of 10-50 wt. %, 15-40 wt. %, 15-30 wt. %, or 10-20 wt. % based on the total weight of the photopolymerizable sol or slurry.

In some embodiments, the polymerizable material contains 20 to 100 wt. % first monomer and 0 to 80 wt. % second monomer based on a total weight of polymerizable material. For example, polymerizable material includes 30 to 100 wt. % first monomer and 0 to 70 wt. % second monomer, 30 to 90 wt. % first monomer and 10 to 70 wt. % second monomer, 30 to 80 wt. % first monomer and 20 to 70 wt. % second monomer, 30 to 70 wt. % first monomer and 30 to 70 wt. % second monomer, 40 to 90 wt. % first monomer and 10 to 60 wt. % second monomer, 40 to 80 wt. % first monomer and 20 to 60 wt. % second monomer, 50 to 90 wt. % first monomer and 10 to 50 wt. % second monomer, or 60 to 90 wt. % first monomer and 10 to 40 wt. % second monomer.

In some embodiments, the polymerizable material contains 0 wt. % first monomer and 100 wt. % second monomer based on a total weight of the polymerizable material.

### Photoinitiator

Photopolymerizable slurries or sols typically further comprise one or more photoinitiators. In certain embodiments the photoinitiator(s) can be characterized by being soluble in a solvent contained in the slurry or sol and/or absorbing radiation within a range from 200 to 500 nm or from 300 to 450 nm. The photoinitiator should be able to start or initiate the curing or hardening reaction of the radiation curable component(s) being present in the photopolymerizable slurries or sols.

The following classes of photoinitiator(s) can be used: a) two-component system where a radical is generated through abstraction of a hydrogen atom from a donor compound; b) one component system where two radicals are generated by cleavage; and/or c) a system comprising an iodonium salt, a visible light sensitizer, and an electron donor compound.

Examples of photoinitiators according to type (a) typically contain a moiety selected from benzophenone, xanthone or quinone in combination with an aliphatic amine.

Examples of photoinitiators according to type (b) typically contain a moiety selected form benzoin ether, acetophenone, benzoyl oxime or acyl phosphine. Suitable exemplary photoinitiators are those available under the trade designation OMNIRAD from IGM Resins (Waalwijk, The Netherlands) and include 1-hydroxycyclohexyl phenyl ketone (OMNIRAD 184), 2,2-dimethoxy-1,2-diphenylethan-1-one (OMNIRAD 651), bis(2,4,6 trimethylbenzoyl)phenylphosphineoxide (OMNIRAD 819), 1-[4-(2-hydroxyethoxy)phenyl]-2-hydroxy-2-methyl-1-propane-1-one (OMNIRAD 2959), 2-benzyl-2-dimethylamino-1-(4-morpholinophenyl)butanone (OMNIRAD 369), 2-methyl-1-[4-(methylthio)phenyl]-2-morpholinopropan-1-one (OMNIRAD 907), 2-hydroxy-2-methyl-1-phenyl propan-1-one (OMNIRAD 1173), 2, 4, 6-trimethylbenzoyldiphenylphosphine oxide (OMNIRAD TPO), and 2, 4, 6-trimethylbenzoylphenyl phosphinate (OMNIRAD TPO-L). Additional suitable photoinitiators include for example and without limitation, Oligo[2-hydroxy-2-methyl-1-[4-(1-methylvinyl)phenyl]propanone] ESACURE ONE (Lamberti S.p.A., Gallarate, Italy), 2-hydroxy-2-methylpropiophenone, benzyl dimethyl ketal, 2-methyl-2-hydroxypropiophenone, benzoin methyl ether, benzoin isopropyl ether, anisoin methyl ether, aromatic sulfonyl chlorides, photoactive oximes, and combinations thereof.

Examples of photoinitiators according to type (c) typically contain the following moieties for each component: Suitable iodonium salts are described in U.S. Pat. Nos. 3,729,313, 3,741,769, 3,808,006, 4,250,053 and 4,394,403, the iodonium salt disclosures of which are incorporated herein by reference. The iodonium salt can be a simple salt, containing an anion such as Cl⁻, Br⁻, I⁻ or C₄H₅SO₃⁻; or a metal complex salt containing an antimonate, arsenate, phosphate or borate such as SbF₅OH⁻ or AsF₆⁻. Mixtures of iodonium salts can be used if desired. For instance, suitable iodonium salts include each of diphenyliodonium hexafluorophosphate and diphenyliodonium chloride, both commercially available from Sigma-Aldrich (St. Louis, Mo.). The visible light sensitizer may be selected from ketones, coumarin dyes (e.g., ketocoumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes and pyridinium dyes. Preferably, the visible light sensitizer is an alpha-diketone; camphorquinone is particularly preferred and commercially available from Sigma-Aldrich. The electron donor compound is typically an alkyl aromatic polyether or an alkyl, aryl amino compound wherein the aryl group is substituted by one or more electron withdrawing groups. Examples of suitable electron withdrawing groups include carboxylic acid, carboxylic acid ester, ketone, aldehyde, sulfonic acid, sulfonate and nitrile groups. The electron donor compound may be selected from polycylic aromatic compounds (such as biphenylenes, naphthalenes, anthracenes, benzanthracenes, pyrenes, azulenes, pentacenes, decacyclenes, and derivatives (e.g., acenaphthenes) and combinations thereof), and N-alkyl carbazole compounds (e.g., N-methyl carbazole). Preferred donor compounds include 4-dimethylaminobenzoic acid, ethyl 4-dimethylaminobenzoate, 3-dimethylaminobenzoic acid, 4-dimethylaminobenzoin, 4-dimethylaminobenzaldehyde, 4-dimethylaminobenzonitrile and 1,2,4-trimethoxybenzene. Photoinitiators according to type (c) are described in detail, for instance, in co-owned U.S. Pat. No. 6,187,833 (Oxman et al).

A photoinitiator can be present in a photopolymerizable slurry or sol described herein in any amount according to the particular constraints of the additive manufacturing process. In some embodiments, a photoinitiator is present in a photopolymerizable slurry or sol in an amount of 0.005 wt. % or more, 0.01 wt. % or more, 0.05 wt. % or more, 0.1 wt. % or more, or 0.3 wt. % or more; and 5% wt. % or less, 4 wt. % or less, 3 wt. % or less, 2 wt. % or less, 1 wt. % or less, or 0.5 wt. % or less, based on the total weight of the photopolymerizable slurry or sol. In some cases, a photoinitiator is present in an amount of about 0.005-5 wt. %, or 0.1-2 wt. %, based on the total weight of the photopolymerizable slurry or sol.

In addition, a photopolymerizable slurry or sol described herein can further comprise one or more sensitizers to increase the effectiveness of one or more photoinitiators that may also be present. In some embodiments, a sensitizer comprises isopropylthioxanthone (ITX) or 2-chlorothioxanthone (CTX). Other sensitizers may also be used. If used in the photopolymerizable composition, a sensitizer can be present in an amount of about 0.001% by weight or more, 0.01% by weight or more, or about 1% by weight or more, based on the total weight of the photopolymerizable slurry or sol.

### Inhibitor

A photopolymerizable slurry or sol optionally also comprises one or more polymerization inhibitors (e.g., photoinhibitors). A polymerization inhibitor is often included in a photopolymerizable slurry or sol to provide additional thermal or photo stability to the composition. An inhibitor may extend the shelf life of the photopolymerizable slurry or sol, help prevent undesired side reactions, and adjust the polymerization process of the radiation curable component(s) present in the slurry or sol. Adding one or more inhibitor(s) to the photopolymerizable slurry or sol may further help to improving the accuracy or detail resolution of the surface of the ceramic article. Specific examples of inhibitor(s) which can be used include: p-methoxyphenol (MOP), hydroquinone monomethylether (MEHQ), 2,6-di-tert-butyl-4-methyl-phenol (BHT; Ionol), phenothiazine, 2,2,6,6-tetramethyl-piperidine-1-oxyl radical (TEMPO) and mixtures thereof.

In some embodiments, a polymerization inhibitor, if used, is present in an amount of about 0.001-5 wt. %, 0.001-1 wt. %, or 0.01-1 wt. %, based on the total weight of the photopolymerizable slurry or sol.

A photopolymerizable slurry or sol as described herein can also comprise one or more absorption modifiers (e.g., dyes, optical brighteners, pigments, etc.) to control the penetration depth of actinic radiation. One suitable optical brightener is Tinopal OB, a benzoxazole, thiophenediyl)bis[5-(1,1-dimethylethyl], available from BASF Corporation (Florham Park, N.J.). The absorption modifier, if used, can be present in an amount of about 0.001-5 wt. %, about 0.01-1 wt. %, about 0.1-3 wt. %, or about 0.1-1 wt. %, based on the total weight of the photopolymerizable slurry or sol.

### Slurries and Sols

The preparation of photopolymerizable slurries or sols is typically conducted under light-restricted conditions to avoid an undesired early polymerization. In some embodiments, the photopolymerizable slurry or sol is prepared by speed mixing the components to form a preferably homogenous slurry or sol. The slurry or sol is typically stored in a suitable device like a vessel, a bottle, cartridge or container before use.

A photopolymerizable slurry or sol (e.g., uncured) has a viscosity profile consistent with the requirements and parameters of one or more additive manufacturing devices (e.g., 3D printing systems). In certain embodiments, the photopolymerizable slurry or sol exhibits a dynamic viscosity at 23 degrees Celsius of 500 milliPascals seconds (mPa·s) or less, 400 mPa·s, 300 mPa·s, 200 mPa·s, 100 mPa·s, 50 mPa·s, or 25 mPa·s or less. In some instances, a photopolymerizable slurry or sol described herein when uncured exhibits a dynamic viscosity of 1 to 500 mPa·s, 1 to 100 mPa·s, or 1 to 50 mPa·s using a Brookfield DV-E Viscometer (Brookfield Engineering Laboratories, Middleboro, Mass.) using disc and cylinder spindles at 23 degrees Celsius and at shear rates of 2 l/s to 20 l/s. In some cases, a photopolymerizable composition described herein when uncured exhibits a dynamic viscosity of less than about 50 mPa·s.

What is claimed is:

1. An additive manufactured article comprising a first portion and a second portion integral to the first portion, wherein the second portion comprises a coupling configured to engage a tool, and wherein the second portion comprises a frangible section at a connection point to the first portion.

2. The article of claim 1, wherein the first portion has a maximum dimension of 30 millimeters (mm) or less, 28 mm or less, 26 mm or less, 24 mm or less, 22 mm or less, 20 mm or less, 18 mm or less, 16 mm or less, 14 mm or less, 12 mm or less, 10 mm or less, 8 mm or less, 6 mm or less, or 4 mm or less; and 0.25 mm or greater, 0.50 mm or greater, 0.75 mm or greater, 1.00 mm or greater, 1.25 mm or greater, 1.50 mm or greater, 1.75 mm or greater, 2.00 mm or greater, 2.50 mm or greater, 3.00 mm or greater, or 3.50 mm or greater.

3. The article of claim 1, wherein the first portion has a shape of a dental restoration or an orthodontic appliance, wherein the dental restoration is selected from a crown, a bridge, an inlay, an onlay, a veneer, a facing, or a coping, and wherein the orthodontic appliance is selected from an attachment, a bracket, a buccal tube, a hook, or a button.

4. The article of claim 1, wherein the frangible section comprises at least two connection points to the first portion.

5. The article of claim 1, further comprising a light guide removably attached to the second portion, wherein the light guide is engaged with the coupling of the second portion.

6. The article of claim 1, wherein the first portion, the second portion, or both, is formed of a ceramic material, a polymeric material, a polymer composite, or a combination thereof.

7. The article of claim 1, wherein the first portion is formed of a material that has a higher ultimate strength than a material of which the frangible section is formed.

8. The article of claim 1, wherein the second portion forms an angle between 45 degrees and 180 degrees between the coupling and the connection point to the first portion.

9. The article of claim 1, further comprising a third portion integral to the second portion, wherein the third portion has a registration shape for the first portion.

10. A method of making an additive manufactured article, the method comprising:
a) obtaining a photopolymerizable material;
b) selectively curing the photopolymerizable material to form an additive manufactured article comprising a first portion and a second portion integral to the first portion, wherein the second portion comprises a coupling configured to engage a tool, and wherein the second portion comprises a frangible section at a connection point to the first portion.

11. The method of claim 10, wherein the photopolymerizable material comprises a first composition and a second composition and the method comprises selectively curing the first composition to form the first portion and selectively curing the second composition to form the second portion.

12. The method of claim 10, wherein the additive manufactured article is the article according to claim 1.

13. A kit comprising:
a) an additive manufactured article comprising a first portion and a second portion integral to the first portion, wherein the second portion comprises a coupling configured to engage a tool, and wherein the second portion comprises a frangible section at a connection point to the first portion; and
b) a tool configured to attach to the coupling.

14. The kit of claim 13, wherein the tool comprises a handle.

15. The kit of claim 13, wherein the additive manufactured article is the article according to claim 1.

16. A method comprising:
a) obtaining a digital three-dimensional model of a patient's dental anatomy comprising a tooth in need of restoration; and
b) computing a digital three-dimensional model of a dental restoration to fit within the patient's dental anatomy, the dental restoration comprising a first portion and a second portion integral to the first portion, wherein the second portion comprises a coupling configured to engage a tool; wherein the computing comprises determining a shape of the dental restoration.

17. The method of claim 16, further comprising preparing the patient's dental anatomy for a dental restoration prior to obtaining the digital three-dimensional model of the patient's dental anatomy.

18. The method of claim 16, wherein the computing further comprises determining an angle between the first portion and the second portion configured to avoid interference of the second portion with features of the patient's dental anatomy

19. The method of claim 16, wherein the computing further comprises computing a digital three-dimensional model of a third portion integral to the second portion, wherein the third portion has a registration shape for the first portion.

20. The method of claim 16, further comprising generating, with an additive manufacturing device by an additive manufacturing process, the dental restoration based on the digital three-dimensional model of the dental restoration.

21. The method of claim 20, further comprising:
c) attaching a tool to the coupling of the second portion;
d) placing the first portion of the dental restoration in contact with the patient's dental anatomy or an indirect bonding tray; and
e) separating the second portion from the first portion at a frangible section located at a connection point to the first portion.

22. A non-transitory machine readable medium comprising data representing a three-dimensional model of an article, when accessed by one or more processors interfacing with a 3D printer, causes the 3D printer to create an additive manufactured article comprising a first portion and a second portion integral to the first portion, wherein the second portion comprises a coupling configured to engage a tool, and wherein the second portion comprises a frangible section at a connection point to the first portion.

23. A method comprising:
a) receiving, by a manufacturing device having one or more processors, a digital object comprising data specifying an article; and
b) generating, with the manufacturing device by an additive manufacturing process, the article based on the digital object, the article comprising a first portion and a second portion integral to the first portion, wherein the second portion comprises a coupling configured to engage a tool, and wherein the second portion comprises a frangible section at a connection point to the first portion.

24. A system comprising:
a) a display that displays a 3D model of an article; and
one or more processors that, in response to the 3D model selected by a user, cause a 3D printer to create a physical object of the article, the article comprising a first portion and a second portion integral to the first portion, wherein the second portion comprises a coupling configured to engage a tool, and wherein the second portion comprises a frangible section at a connection point to the first portion.
